(19) United States
(12) Patent Application Publication
(10) Pub. No.: US 2022/0186432 A1
(43) Pub. Date: Jun. 16, 2022

(54) DYE DISCHARGE FLUID

(71) Applicant: Hewlett-Packard Development Company, L.P., Spring, TX (US)

(72) Inventors: Dennis Z. Guo, San Diego, CA (US); Jie Zheng, San Diego, CA (US); Ronald Albert Askeland, San Diego, CA (US)

(73) Assignee: Hewlett-Packard Development Company, L.P., Spring, TX (US)

(21) Appl. No.: 17/417,562

(22) PCT Filed: Jul. 25, 2019
(86) PCT No.: PCT/US2019/043470

§ 371 Date: Jun. 23, 2021

(51) Int. Cl. D06P 5/30; C09D 11/328; C09D 11/38; C09D 11/037; C09D 11/033; D06P 5/20

(52) U.S. Cl. CPC D06P 5/30; C09D 11/328; C09D 11/38; D06P 5/2011; C09D 11/033; D06P 5/2077; C09D 11/037

(57) ABSTRACT

An example of a dye discharge fluid includes a water-soluble organic solvent, a heat activated reducing agent, and water. A pH of the dye discharge fluid is less than 7. The dye discharge fluid may be used with a colored pigmented inkjet ink, a white pigmented inkjet ink, and/or a colored textile fabric, and may be included in a fluid set and/or a printing kit.

### BACKGROUND

Textile printing methods often include rotary and/or flat-screen printing. Traditional analog printing typically involves the creation of a plate or a screen, i.e., an actual physical image from which ink is transferred to the textile. Both rotary and flat screen printing have great volume throughput capacity, but also have limitations on the maximum image size that can be printed. For large images, pattern repeats are used. Conversely, digital inkjet printing enables greater flexibility in the printing process, where images of any desirable size can be printed immediately from an electronic image without pattern repeats. Inkjet printers are gaining acceptance for digital textile printing, e.g., for creating signs, banners, artwork, apparel, wall coverings, window coverings, upholstery, pillows, blankets, flags, tote bags, clothing, etc. Inkjet printing is a non-impact printing method that utilizes electronic signals to control and direct droplets or a stream of ink to be deposited on media.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a flow diagram illustrating examples of a printing method;

FIG. 2 is a schematic diagram of an example of a printing system;

FIG. 3A through FIG. 3C depict black and white reproductions of originally colored photographs of prints generated on black 100% cotton with an example of the dye discharge fluid disclosed herein printed thereon and one of: no heating process (FIG. 3A), heated with a hot press (FIG. 3B), or exposed to UV energy (FIG. 3C);

FIG. 4A through FIG. 4C depict black and white reproductions of originally colored photographs of prints generated on black 50% cotton/50% polyester with an example of the dye discharge fluid disclosed herein printed thereon and one of no heating process (FIG. 4A), heated with a hot press (FIG. 4B), or exposed to UV energy (FIG. 4C);

FIG. 5A through FIG. 5C depict black and white reproductions of originally colored photographs of prints generated on red 50% cotton/50% polyester with an example of the dye discharge fluid disclosed herein printed thereon and one of: no heating process (FIG. 5A), heated with a hot press (FIG. 5B), or exposed to UV energy (FIG. 5C);

FIG. 6A through FIG. 6C depict black and white reproductions of originally colored photographs of prints generated on black 100% cotton with an example of the dye discharge fluid disclosed herein and an example cyan pigmented inkjet ink printed thereon, and one of: no heating process (FIG. 6A), heated with a hot press (FIG. 6B), or exposed to UV energy (FIG. 6C);

FIG. 7A through FIG. 7C depict black and white reproductions of originally colored photographs of prints generated on black 100% cotton with an example of the dye discharge fluid disclosed herein and an example magenta pigmented inkjet ink printed thereon, and one of: no heating process (FIG. 7A), heated with a hot press (FIG. 7B), or exposed to UV energy (FIG. 7C);

FIG. 8A through FIG. 8C depict black and white reproductions of originally colored photographs of prints generated on black 100% cotton with an example of the dye discharge fluid disclosed herein and an example yellow pigmented inkjet ink printed thereof, and one of: no heating process (FIG. 8A), heated with a hot press (FIG. 8B), or exposed to UV energy (FIG. 8C);

FIG. 9 is a graph depicting the ultraviolet-visible (UV-Vis) specta (absorbance on the Y- axis and wavelength, in nm, on the X-axis) for a yellow ink, a cyan ink, and a magenta ink, each at 1:2500 dilution;

FIG. 10 is a chemical formula illustrating an example of a reaction between formaldehyde sulfoxylate and an azo dye; and

FIG. 11 is a chemical formula illustrating an example of a reaction between formaldehyde sulfoxylate and an anthraquinone dye.

### DETAILED DESCRIPTION

The textile market is a major industry, and printing on textiles, such as cotton, etc., has been evolving to include digital printing methods. Some digital printing methods enable direct to garment (or other textile) printing. More than two-thirds of the textile printing that is performed utilizes a colored textile fabric, which usually involves printing a thick layer (e.g., greater than 200 grams per square meter (gsm)) of white ink as an underbase before printing colored ink. Without the white ink underbase, the colored ink may not be visible on the colored textile fabric and/or the color of the printed ink may be skewed. However, the thick layer of white ink may cause the printed textile fabric to have an undesirable feel or pliability/stiffness (commonly referred to as “hand”).

Disclosed herein is a dye discharge fluid suitable for digital inkjet printing on a variety of colored textile fabrics, including colored cotton and colored cotton blends. It has been found that the dye discharge fluid disclosed herein is capable of discoloring colored textile fabrics. The discharge fluid formulation includes a strong reducing agent that, when activated by heat, is capable of reducing reactive dyes, such as azo dye(s) and/or anthraquinone dye(s) in the colored textile fabrics. The reduction discolors the portion of the textile fabrics upon which dye discharge fluid is applied. The dye discharge fluid disclosed herein can be used to generate a lighter image on a colored textile fabric, or to whiten an area of the textile fabric where one or more colored pigmented ink(s) will be deposited to form the image. In some examples, the use of the dye discharge fluid may allow the colored pigmented ink(s) to be visible, and exhibit the desirable color, on the textile fabric without a white ink underbase. In other examples, the use of the dye discharge fluid may reduce the amount of white ink that is printed prior to the deposition of colored pigmented ink(s).

It has also been found that the reducing agent included in the dye discharge fluid is stable (e.g., in terms of viscosity) at a pH less than 7 without the addition of a chelating agent.

Throughout this disclosure, a weight percentage that is referred to as “wt % active” or “wt % actives” refers to the loading of an active component of a dispersion or other formulation that is present in the dye discharge fluid, the color pigmented inkjet ink, or the white pigmented inkjet ink. For example, the colored pigment may be present in a water-based formulation (e.g., a stock solution or dispersion) before being incorporated into the colored pigmented inkjet ink. In this example, the wt % actives of the color pigment accounts for the loading (as a weight percent) of the color pigment that is present in the colored pigmented inkjet ink, and does not account for the weight of the other components (e.g., water, etc.) that are present in the formulation with the color pigment. The term “wt %,” without the term actives, refers to either i) the loading (in the dye discharge fluid, the color pigmented inkjet ink, or the white pigmented inkjet ink) of a 100% active component that does not include other non-active components therein, or the loading (in the dye discharge fluid, the color pigmented inkjet ink, or the white pigmented inkjet ink) of a material or component that is used “as is” and thus the wt % accounts for both active and non-active components.

Dye Discharge Fluids

Examples of the dye discharge fluid disclosed herein will now be described. As mentioned above, the dye discharge fluid is capable of discoloring colored textile fabrics.

In some examples, the dye discharge fluid comprises: a water-soluble organic solvent; a heat activated reducing agent; and water; wherein a pH of the dye discharge fluid is less than 7. In some of these examples, the dye discharge fluid consists of these components with no other components. In these examples, the dye discharge fluid consists of the water-soluble organic solvent, the heat activated reducing agent, and water. In other examples, the dye discharge fluid may include additional components. In some of these examples, the dye discharge fluid further comprises a surfactant.

In some examples, the dye discharge fluid excludes a chelating agent. As mentioned, the dye discharge fluid disclosed herein exhibits stability at an acidic pH, and chelating agent(s), such as ethylenediaminetetraacetic acid (EDTA), are not effective at such pHs. Therefore, examples of the dye discharge fluid exclude a chelating agent.

Examples of the dye discharge fluid disclosed herein may be used in a thermal inkjet printer or in a piezoelectric printer to print on a colored textile fabric. The viscosity of the dye discharge fluid may be adjusted for the type of printhead that is to be used, and the viscosity may be adjusted by adjusting the water-soluble organic solvent level and/or by adding a viscosity modifier. When used in a thermal inkjet printer, the viscosity of the dye discharge fluid may be modified to range from about 1 cP to about 9 cP (at 20° C. to 25° C.), and when used in a piezoelectric printer, the viscosity of the dye discharge fluid may be modified to range from about 1 cP to about 20 cP (at 20° C. to 25° C.), depending on the type of the printhead that is being used (e.g., low viscosity printheads, medium viscosity printheads, or high viscosity printheads).

The dye discharge fluid disclosed herein is stable. As used herein, the term “stable” refers to the dye discharge fluid's ability to remain substantially unchanged over time. To determine the stability of the dye discharge fluid, the viscosity of the fluid may be measured over time or after exposure to accelerated storage conditions, and the percentage of viscosity change may be determined. Accelerated storage conditions may include at least 1 week of storage at 60° C. The viscosity may be considered to be “substantially unchanged over time” when the percentage of viscosity increase is 10% or less.

The dye discharge fluid has a pH that is less 7. In some examples, the pH ranges from about 3 to about 6. In another example, the pH of the dye discharge fluid ranges from about 4 to about 5. In still another example, the pH of the dye discharge fluid ranges from about 4 to about 4.5.

Water-Soluble Organic Solvents

As mentioned above, the dye discharge fluid includes the water-soluble organic solvent. Examples of the water-soluble organic solvent include alcohols, amides, esters, ketones, lactones, and ethers. In additional detail, the water-soluble organic solvent may include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers (e.g., DOWANOL™ TPM (from Dow Chemical)), higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples of alcohols may include ethanol, isopropyl alcohol, butyl alcohol, and benzyl alcohol. Other specific examples include 2-ethyl-2-(hydroxymethyl)-1,3-propane diol (EPHD), dimethyl sulfoxide, sulfolane, and/or alkyldiols such as 1,2-hexanediol.

The water-soluble organic solvent may also be a polyhydric alcohol or a polyhydric alcohol derivative. Examples of polyhydric alcohols may include ethylene glycol, diethylene glycol, triethylene glycol, tetraethylene glycol, propylene glycol, butylene glycol1,5-pentanediol, 1,2-hexanediol, 2-methyl-1,3-propanediol, 1,2-butanediol,1,2,6-hexanetriol, glycerin (also known as glycerol), trimethylolpropane, and xylitol. Examples of polyhydric alcohol derivatives may include an ethylene oxide adduct of diglycerin.

The water-soluble organic solvent may also be a nitrogen-containing solvent. Examples of nitrogen-containing solvents may include 2-pyrrolidone, 1-(2-hydroxyethyl)-2-pyrrolidone, N-methyl-2-pyrrolidone, cyclohexylpyrrolidone, and triethanolamine.

It is to be understood that the water-soluble organic solvent may also include a combination of any of the above examples.

The water-soluble organic solvent may be present in the dye discharge fluid in an amount ranging from about 4 wt % to about 30 wt % (based on the total weight of the dye discharge fluid). In an example, the total amount of water-soluble organic solvent(s) present in the dye discharge fluid is about 12 wt % (based on the total weight of the dye discharge fluid). In another example, the total amount of water-soluble organic solvent(s) present in the dye discharge fluid is about 8 wt % (based on the total weight of the dye discharge fluid).

Heat Activated Reducing Agents

The dye discharge fluid includes the heat activated reducing agent to discolor a reactive dye (e.g., an azo dye, an anthraquinone dye, a combination thereof) in contact with the dye discharge fluid upon activation.

In some examples, the heat activated reducing agent is selected from the group consisting of zinc formaldehyde sulfoxylate, sodium formaldehyde sulfoxylate, thiourea dioxide, sodium hydrosulfite (a.k.a., sodium dithionite), and combinations thereof. In one example, the heat activated reducing agent is zinc formaldehyde sulfoxylate.

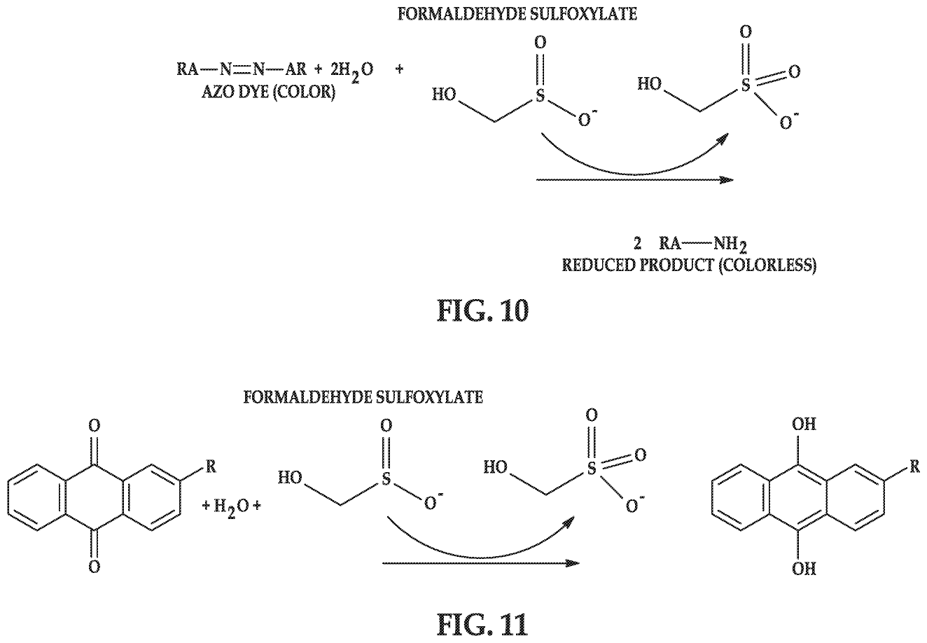

The heat activated reducing agent, when activated by heat, is capable of reducing azo dye(s) and/or anthraquinone dye(s). For example, formaldehyde sulfoxylate (and similarly zinc formaldehyde sulfoxylate) may reduce an azo dye according to the reaction shown in FIG. 10, where each of RA and AR is an unsubstituted or substituted aryl group. RA and AR may also be the same aryl group or may be different aryl groups. For another example, formaldehyde sulfoxylate (and similarly zinc formaldehyde sulfoxylate) may reduce an anthraquinone dye according to the reaction shown in FIG. 11, where R is —H, —SO₃H, —O(CH₂)₂OH, —OC₆H₅, —CH₂OH, etc. The aromatic ring(s) of the anthraquinone structure may also be para-substituted with —NH₂ and —OH, with —NHCH₂CH(CH₃)₂ groups, etc. The reduction discolors the azo dye(s) and/or anthraquinone dye(s). As such, the heat activated reducing agent is capable of discoloring textile fabrics that are colored/dyed with azo dye(s) and/or anthraquinone dye(s).

In some examples, the heat activated reducing agent also includes a divalent metal cation that can help to fix the pigment in a subsequently deposited pigmented ink (e.g., a colored pigmented inkjet ink or a white pigmented inkjet ink). For example, the zinc (II) cation in zinc (II) formaldehyde sulfoxylate is a divalent metal cation that may help to fix the pigment in a subsequently deposited pigmented ink.

In some examples, the heat activated reducing agent is present in the dye discharge fluid in an amount ranging from about 2 wt % to about 16 wt % based on a total weight of the dye discharge fluid. In other examples, the heat activated reducing agent is present in the dye discharge fluid in an amount ranging from about 4 wt % to about 10 wt % based on the total weight of the dye discharge fluid. In still another example, the heat activated reducing agent is present in the dye discharge fluid in an amount of about 6 wt % based on the total weight of the dye discharge fluid.

Water

It is to be understood that water is present in, and makes up a balance of the dye discharge fluid. As such, the weight percentage of the water present in the dye discharge fluid will depend, in part, upon the weight percentages of the other components. The water may be purified or deionized water.

Surfactants

In some examples, the dye discharge fluid further comprises a surfactant. The surfactant may include cationic and/or non-ionic surfactants.

Examples of the cationic surfactant include quaternary ammonium salts, such as benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride, domiphen bromide, alkylbenzyldimethylammonium chlorides, distearyldimethylammonium chloride, diethyl ester dimethyl ammonium chloride, and glycine betaine.

Examples of the non-ionic surfactant may include polyoxyethylene alkyl ether, polyoxyethylene alkyl phenyl ether, polyoxyethylene fatty acid ester, sorbitan fatty acid ester, polyoxyethylene sorbitan fatty acid ester, polyoxyethylene sorbitol fatty acid ester, glycerin fatty acid ester, polyoxyethylene glycerin fatty acid ester, polyglycerin fatty acid ester, polyoxyethylene alkylamine, polyoxyethylene fatty acid amide, alkylalkanolamide, polyethylene glycol polypropylene glycol block copolymer, acetylene glycol, and a polyoxyethylene adduct of acetylene glycol. Specific examples of the non-ionic surfactant may include polyoxyethylenenonyl phenylether, polyoxyethyleneoctyl phenylether, and polyoxyethylenedodecyl. Further examples of the non-ionic surfactant may include silicon surfactants such as a polysiloxane oxyethylene adduct; fluorine surfactants such as perfluoroalkylcarboxylate, perfluoroalkyl sulfonate, and oxyethyleneperfluoro alkylether; and biosurfactants such as spiculisporic acid, rhamnolipid, and lysolecithin.

In some examples, the dye discharge fluid may include a non-ionic silicone-free alkoxylated alcohol surfactant such as, for example, TEGO® Wet 510 (Evonik Degussa) and/or a non-ionic self-emulsifiable wetting agent based on acetylenic diol chemistry, such as, for example, SURFYNOL® SE-F (Evonik Degussa). Other suitable commercially available non-ionic surfactants include SURFYNOL® 465 (ethoxylatedacetylenic diol), SURFYNOL® 440 (an ethoxylated low-foam wetting agent) SURFYNOL® CT-211 (now CARBOWET® GA-211, non-ionic, alkylphenylethoxylate and solvent free), and SURFYNOL® 104 (non-ionic wetting agent based on acetylenic diol chemistry), (all of which are from Evonik Degussa); ZONYL® FSO (a.k.a. CAPSTONE®, which is a water-soluble, ethoxylated non-ionic fluorosurfactant from DuPont); TERGITOL® TMN-3 and TERGITOL® TMN-6 (both of which are branched secondary alcohol ethoxylate, non-ionic surfactants), and TERGITOL® 15-S-3, TERGITOL® 15-S-5, and TERGITOL® 15-S-7 (each of which is a secondary alcohol ethoxylate, non-ionic surfactant) (all of the TERGITOL® surfactants are available from The Dow Chemical Company); and BYK® 345, BYK® 346, BYK® 347, BYK® 348, BYK® 349 (each of which is a non-ionic silicone surfactant) (all of which are available from BYK Additives and Instruments).

In any of the examples disclosed herein, the surfactant may be present in the dye discharge fluid in an amount ranging from about 0.01 wt % active to about 5 wt % active (based on the total weight of the dye discharge fluid). In an example, the surfactant is present in the dye discharge fluid in an amount ranging from about 0.05 wt % active to about 3 wt % active, based on the total weight of the dye discharge fluid. In another example, the surfactant is present in the dye discharge fluid in an amount of about 0.15 wt % active, based on the total weight of the dye discharge fluid. In still another example, the surfactant is present in the dye discharge fluid in an amount of about 0.3 wt % active, based on the total weight of the dye discharge fluid.

Additives

In some examples, the dye discharge fluid further includes an additive, such as an anti-decel agent and/or an antimicrobial agent.

In some examples, the dye discharge fluid includes anti-decel agent(s). The anti-decel agent may function as a humectant. Decel refers to a decrease in drop velocity over time with continuous firing. In the examples disclosed herein, the anti-decel agent(s) is/are included to assist in preventing decel. In some examples, the anti-decel agent may improve the jettability of the dye discharge fluid. The anti-decel agent(s) may be present in the dye discharge fluid in an amount ranging from about 0.2 wt % active to about 5 wt % active (based on the total weight of the dye discharge fluid). In an example, the anti-decel agent is present in the dye discharge fluid in an amount of about 1 wt % active, based on the total weight of the dye discharge fluid.

An example of a suitable anti-decel agent is ethoxylated glycerin having the following formula:

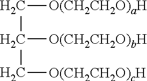

in which the total of a+b+c ranges from about 5 to about 60, or in other examples, from about 20 to about 30. An example of the ethoxylated glycerin is LIPON IC® EG-1 (LEG-1, glycereth-26, a+b+c=26, available from Lipo Chemicals).

In some examples, the dye discharge fluid may also include antimicrobial agent(s). Antimicrobial agents are also known as biocides and/or fungicides. In an example, the total amount of antimicrobial agent(s) in the dye discharge fluid ranges from about 0.01 wt % active to about 0.05 wt % active (based on the total weight of the dye discharge fluid). In another example, the total amount of antimicrobial agent(s) in the dye discharge fluid is about 0.044 wt % active (based on the total weight of the dye discharge fluid).

Examples of suitable antimicrobial agents include the NUOSEPT® (Ashland Inc.), UCARCIDE™ or KORDEK™ or ROCIMA™ (Dow Chemical Co.), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof.

Colored Pigmented Inkjet Inks

Examples of the colored pigmented inkjet ink disclosed herein will now be described. Examples of the colored pigmented inkjet ink include a color pigment, a co-solvent, and a balance of water. In some examples, the colored pigmented inkjet ink consists of the color pigment, the co-solvent, and the balance of water. In other examples, the colored pigmented inkjet ink may include additional components, such as a polymeric binder, a surfactant, an anti-decel agent, an anti-kogation agent, an antimicrobial agent, a pH adjuster, or combinations thereof.

Examples of the colored pigmented inkjet ink disclosed herein may be used in a thermal inkjet printer or in a piezoelectric printer to print on a textile fabric. The viscosity of the colored pigmented inkjet ink may be adjusted for the type of printhead that is to be used, and the viscosity may be adjusted by adjusting the co-solvent level, adjusting the polymeric binder level, and/or adding a viscosity modifier. When used in a thermal inkjet printer, the viscosity of the colored pigmented inkjet ink may be modified to range from about 1 cP to about 9 cP (at 20° C. to 25° C.), and when used in a piezoelectric printer, the viscosity of the colored pigmented inkjet ink may be modified to range from about 1 cP to about 20 cP (at 20° C. to 25° C.), depending on the type of the printhead that is being used (e.g., low viscosity printheads, medium viscosity printheads, or high viscosity printheads).

Color Pigments

The color pigment in the colored pigmented inkjet ink is resistant to discoloration by the dye discharge fluid. In other words, the color pigment either (i) does not become reduced in the presence of the activated reducing agent of the discharge fluid or (ii) does not change color when reduced in the presence of the activated reducing agent of the discharge fluid.

The color pigment may be incorporated into the colored pigmented inkjet ink as a colored pigment dispersion. The colored pigment dispersion may include a color pigment and a separate dispersant, or may include a self-dispersed color pigment.

For the colored pigment dispersions disclosed herein, it is to be understood that the color pigment and separate dispersant or the self-dispersed color pigment (prior to being incorporated into the ink formulation), may be dispersed in water alone or in combination with an additional water soluble or water miscible co-solvent, such as 2-pyrrolidone, 1-(2-hydroxyethyl)-2-pyrrolidone, glycerol, 2-methyl-1,3-propanediol, 1,2-butane diol, diethylene glycol, triethylene glycol, tetraethylene glycol, or a combination thereof. It is to be understood however, that the liquid components of the colored pigment dispersion become part of the liquid vehicle in the colored pigmented inkjet ink.

Whether separately dispersed or self-dispersed, the color pigment can be any of a number of primary or secondary colors, or black. As specific examples, the pigment may be any non-white color pigment, including, as examples, a cyan pigment, a magenta pigment, a yellow pigment, a black pigment, a violet pigment, a green pigment, a brown pigment, an orange pigment, a purple pigment, a black pigment, or combinations thereof. It is to be understood that the color pigment is not a white pigment.

Pigments and Separate Dispersants

Examples of the colored pigmented inkjet ink may include a color pigment that is not self-dispersing and a separate dispersant. Examples of these color pigments, as well as suitable dispersants for these color pigments will now be described.

Examples of suitable blue or cyan organic pigments include C.I. Pigment Blue 1, C.I. Pigment Blue 2, C.I. Pigment Blue 3, C.I. Pigment Blue 15, Pigment Blue 15:3, C.I. Pigment Blue 15:4, C.I. Pigment Blue 16, C.I. Pigment Blue 18, C.I. Pigment Blue 22, C.I. Pigment Blue 25, C.I. Pigment Blue 60, C.I. Pigment Blue 65, C.I. Pigment Blue 66, C.I. Vat Blue 4, and C.I. Vat Blue 60.

Examples of suitable magenta, red, or violet organic pigments include C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 14, C.I. Pigment Red 15, C.I. Pigment Red 16, C.I. Pigment Red 17, C.I. Pigment Red 18, C.I. Pigment Red 19, C.I. Pigment Red 21, C.I. Pigment Red 22, C.I. Pigment Red 23, C.I. Pigment Red 30, C.I. Pigment Red 31, C.I. Pigment Red 32, C.I. Pigment Red 37, C.I. Pigment Red 38, C.I. Pigment Red 40, C.I. Pigment Red 41, C.I. Pigment Red 42, C.I. Pigment Red 48(Ca), C.I. Pigment Red 48(Mn), C.I. Pigment Red 57(Ca), C.I. Pigment Red 57:1, C.I. Pigment Red 88, C.I. Pigment Red 112, C.I. Pigment Red 114, C.I. Pigment Red 122, C.I. Pigment Red 123, C.I. Pigment Red 144, C.I. Pigment Red 146, C.I. Pigment Red 149, C.I. Pigment Red 150, C.I. Pigment Red 166, C.I. Pigment Red 168, C.I. Pigment Red 170, C.I. Pigment Red 171, C.I. Pigment Red 175, C.I. Pigment Red 176, C.I. Pigment Red 177, C.I. Pigment Red 178, C.I. Pigment Red 179, C.I. Pigment Red 184, C.I. Pigment Red 185, C.I. Pigment Red 187, C.I. Pigment Red 202, C.I. Pigment Red 209, C.I. Pigment Red 219, C.I. Pigment Red 224, C.I. Pigment Red 245, C.I. Pigment Red 286, C.I. Pigment Violet 19, C.I. Pigment Violet 23, C.I. Pigment Violet 32, C.I. Pigment Violet 33, C.I. Pigment Violet 36, C.I. Pigment Violet 38, C.I. Pigment Violet 43, and C.I. Pigment Violet 50. Any quinacridone pigment or a co-crystal of quinacridone pigments may be used for magenta inks.

Examples of suitable yellow organic pigments include C.I. Pigment Yellow 1, C.I. Pigment Yellow 2, C.I. Pigment Yellow 3, C.I. Pigment Yellow 4, C.I. Pigment Yellow 5, C.I. Pigment Yellow 6, C.I. Pigment Yellow 7, C.I. Pigment Yellow 10, C.I. Pigment Yellow 11, C.I. Pigment Yellow 12, C.I. Pigment Yellow 13, C.I. Pigment Yellow 14, C.I. Pigment Yellow 16, C.I. Pigment Yellow 17, C.I. Pigment Yellow 24, C.I. Pigment Yellow 34, C.I. Pigment Yellow 35, C.I. Pigment Yellow 37, C.I. Pigment Yellow 53, C.I. Pigment Yellow 55, C.I. Pigment Yellow 65, C.I. Pigment Yellow 73, C.I. Pigment Yellow 74, C.I. Pigment Yellow 75, C.I. Pigment Yellow 77, C.I. Pigment Yellow 81, C.I. Pigment Yellow 83, C.I. Pigment Yellow 93, C.I. Pigment Yellow 94, C.I. Pigment Yellow 95, C.I. Pigment Yellow 97, C.I. Pigment Yellow 98, C.I. Pigment Yellow 99, C.I. Pigment Yellow 108, C.I. Pigment Yellow 109, C.I. Pigment Yellow 110, C.I. Pigment Yellow 113, C.I. Pigment Yellow 114, C.I. Pigment Yellow 117, C.I. Pigment Yellow 120, C.I. Pigment Yellow 122, C.I. Pigment Yellow 124, C.I. Pigment Yellow 128, C.I. Pigment Yellow 129, C.I. Pigment Yellow 133, C.I. Pigment Yellow 138, C.I. Pigment Yellow 139, C.I. Pigment Yellow 147, C.I. Pigment Yellow 151, C.I. Pigment Yellow 153, C.I. Pigment Yellow 154, C.I. Pigment Yellow 155, C.I. Pigment Yellow 167, C.I. Pigment Yellow 172, C.I. Pigment Yellow 180, C.I. Pigment Yellow 185, and C.I. Pigment Yellow 213.

Carbon black may be a suitable inorganic black pigment. Examples of carbon black pigments include those manufactured by Mitsubishi Chemical Corporation, Japan (such as, e.g., carbon black No. 2300, No. 900, MCF88, No. 33, No. 40, No. 45, No. 52, MA7, MA8, MA100, and No. 2200B); various carbon black pigments of the RAVEN® series manufactured by Columbian Chemicals Company, Marietta, Ga., (such as, e.g., RAVEN® 5750, RAVEN® 5250, RAVEN® 5000, RAVEN® 3500, RAVEN® 1255, and RAVEN® 700); various carbon black pigments of the REGAL® series, BLACK PEARLS® series, the MOGUL® series, or the MONARCH® series manufactured by Cabot Corporation, Boston, Mass., (such as, e.g., REGAL® 400R, REGAL® 330R, REGAL® 660R, BLACK PEARLS® 700, BLACK PEARLS® 800, BLACK PEARLS® 880, BLACK PEARLS® 1100, BLACK PEARLS® 4350, BLACK PEARLS® 4750, MOGUL® E, MOGUL® L, and ELFTEX® 410); and various black pigments manufactured by Evonik Degussa Orion Corporation, Parsippany, N.J., (such as, e.g., Color Black FW1, Color Black FW2, Color Black FW2V, Color Black FW18, Color Black FW200, Color Black S150, Color Black S160, Color Black S170, PRINTEX® 35, PRINTEX® 75, PRINTEX® 80, PRINTEX® 85, PRINTEX® 90, PRINTEX® U, PRINTEX® V, PRINTEX® 140U, Special Black 5, Special Black 4A, and Special Black 4). An example of an organic black pigment includes aniline black, such as C.I. Pigment Black 1.

Some examples of green organic pigments include C.I. Pigment Green 1, C.I. Pigment Green 2, C.I. Pigment Green 4, C.I. Pigment Green 7, C.I. Pigment Green 8, C.I. Pigment Green 10, C.I. Pigment Green 36, and C.I. Pigment Green 45.

Examples of brown organic pigments include C.I. Pigment Brown 1, C.I. Pigment Brown 5, C.I. Pigment Brown 22, C.I. Pigment Brown 23, C.I. Pigment Brown 25, C.I. Pigment Brown 41, and C.I. Pigment Brown 42.

Some examples of orange organic pigments include C.I. Pigment Orange 1, C.I. Pigment Orange 2, C.I. Pigment Orange 5, C.I. Pigment Orange 7, C.I. Pigment Orange 13, C.I. Pigment Orange 15, C.I. Pigment Orange 16, C.I. Pigment Orange 17, C.I. Pigment Orange 19, C.I. Pigment Orange 24, C.I. Pigment Orange 34, C.I. Pigment Orange 36, C.I. Pigment Orange 38, C.I. Pigment Orange 40, C.I. Pigment Orange 43, C.I. Pigment Orange 64, C.I. Pigment Orange 66, C.I. Pigment Orange 71, and C.I. Pigment Orange 73.

The average particle size of the color pigments may range anywhere from about 20 nm to about 200 nm. In an example, the average particle size ranges from about 80 nm to about 150 nm. As used herein, the term “average particle size” may refer to a volume-weighted mean diameter of a particle distribution. The average particle size of any solids disclosed herein, including the average particle size of the color pigments, can be determined using a NANOTRAC® Wave device, from Microtrac, e.g., NANOTRAC® Wave II or NANOTRAC® 150, etc., which measures particles size using dynamic light scattering. Average particle size can be determined using particle size distribution data generated by the NANOTRAC® Wave device.

Any of the color pigments mentioned herein can be dispersed by a separate dispersant, such as a styrene (meth)acrylate dispersant, or another dispersant suitable for keeping the color pigment suspended in the liquid vehicle. For example, the dispersant can be any dispersing (meth)acrylate polymer, or other type of polymer, such as maleic polymer or a dispersant with aromatic groups and a poly(ethylene oxide) chain.

In one example, (meth)acrylate polymer can be a styrene-acrylic type dispersant polymer, as it can promote π-stacking between the aromatic ring of the dispersant and various types of pigments, such as copper phthalocyanine pigments, for example. In this example, the colored pigmented inkjet ink further comprises a styrene acrylic polymeric dispersant. In one example, the styrene-acrylic dispersant can have a weight average molecular weight (Mw) ranging from about 2,000 to about 30,000. Any weight average molecular weight throughout this disclosure is in g/mol or Daltons. In another example, the styrene-acrylic dispersant can have a weight average molecular weight ranging from about 8,000 to about 28,000, from about 12,000 to about 25,000, from about 15,000 to about 25,000, from about 15,000 to about 20,000, or about 17,000. Regarding the acid number, the styrene-acrylic dispersant can have an acid number from 100 to 350, from 120 to 350, from 150 to 250, from 155 to 185, or about 172, for example. Example commercially available styrene-acrylic dispersants can include JONCRYL® 671, JONCRYL® 71, JONCRYL® 96, JONCRYL® 680, JONCRYL® 683, JONCRYL® 678, JONCRYL® 690, JONCRYL® 296, JONCRYL® 696 or JONCRYL® ECO 675 (all available from BASF Corp.).

The term “(meth)acrylate” or “(meth)acrylic acid” or the like refers to monomers, copolymerized monomers, etc., that can either be acrylate or methacrylate (or a combination of both), or acrylic acid or methacrylic acid (or a combination of both). Also, in some examples, the terms “(meth)acrylate” and “(meth)acrylic acid” can be used interchangeably, as acrylates and methacrylates are salts and esters of acrylic acid and methacrylic acid, respectively. Furthermore, mention of one compound over another can be a function of pH. For examples, even if the monomer used to form the polymer was in the form of a (meth)acrylic acid during preparation, pH modifications during preparation or subsequently when added to an inkjet ink can impact the nature of the moiety as well (acid form vs. salt or ester form). Thus, a monomer or a moiety of a polymer described as (meth)acrylic acid or as (meth)acrylate should not be read so rigidly as to not consider relative pH levels, ester chemistry, and other general organic chemistry concepts.

The following are some example color pigment and separate dispersant combinations: a carbon black pigment with a styrene acrylic dispersant; PB 15:3 (cyan pigment) with a styrene acrylic dispersant; PR122 (magenta pigment) or a co-crystal of PR122 and PV19 (magenta pigment) with a styrene acrylic dispersant; or PY74 (yellow pigment) or PY155 (yellow pigment) with a styrene acrylic dispersant.

In an example, the color pigment is present in an amount ranging from about 1 wt % active to about 10 wt % active, based on a total weight of the colored pigmented inkjet ink. In another example, the color pigment is present in the colored pigmented inkjet ink in an amount ranging from about 1 wt % active to about 6 wt % active of the total weight of the colored pigmented inkjet ink. In still another example, the color pigment is present in the colored pigmented inkjet ink in an amount ranging from about 2 wt % active to about 6 wt % active of the total weight of the colored pigmented inkjet ink. When the separate dispersant is used, the separate dispersant may be present in an amount ranging from about 0.05 wt % active to about 6 wt % active of the total weight of the colored pigmented inkjet ink. In some examples, the ratio of color pigment to separate dispersant may range from 0.5 (1:2) to 10 (10:1).

Self-Dispersed Pigments

In other examples, the colored pigmented inkjet ink includes a self-dispersed color pigment, which includes a color pigment and an organic group attached thereto.

Any of the color pigments set forth herein may be used, such as carbon, phthalocyanine, quinacridone, azo, or any other type of organic pigment, as long as at least one organic group that is capable of dispersing the color pigment is attached to the color pigment.

The organic group that is attached to the color pigment includes at least one aromatic group, an alkyl (e.g., C1 to C20), and an ionic or ionizable group.

The aromatic group may be an unsaturated cyclic hydrocarbon containing one or more rings and may be substituted or unsubstituted, for example with alkyl groups. Aromatic groups include aryl groups (for example, phenyl, naphthyl, anthracenyl, and the like) and heteroaryl groups (for example, imidazolyl, pyrazolyl, pyridinyl, thienyl, thiazolyl, furyl, triazinyl, indolyl, and the like).

The alkyl may be branched or unbranched, substituted or unsubstituted.

The ionic or ionizable group may be at least one phosphorus-containing group, at least one sulfur-containing group, or at least one carboxylic acid group.

In an example, the at least one phosphorus-containing group has at least one P—O bond or P═O bond, such as at least one phosphonic acid group, at least one phosphinic acid group, at least one phosphinous acid group, at least one phosphite group, at least one phosphate, diphosphate, triphosphate, or pyrophosphate groups, partial esters thereof, or salts thereof. By “partial ester thereof”, it is meant that the phosphorus-containing group may be a partial phosphonic acid ester group having the formula —PO3RH, or a salt thereof, wherein R is an aryl, alkaryl, aralkyl, or alkyl group. By “salts thereof”, it is meant that the phosphorus-containing group may be in a partially or fully ionized form having a cationic counterion.

When the organic group includes at least two phosphonic acid groups or salts thereof, either or both of the phosphonic acid groups may be a partial phosphonic ester group. Also, one of the phosphonic acid groups may be a phosphonic acid ester having the formula —PO3R2, while the other phosphonic acid group may be a partial phosphonic ester group, a phosphonic acid group, or a salt thereof. In some instances, it may be desirable that at least one of the phosphonic acid groups is either a phosphonic acid, a partial ester thereof, or salts thereof. When the organic group includes at least two phosphonic acid groups, either or both of the phosphonic acid groups may be in either a partially or fully ionized form. In these examples, either or both may of the phosphonic acid groups have the formula —PO3H2, —PO3H— M+(monobasic salt), or —PO3-2 M+2 (dibasic salt), wherein M+ is a cation such as Na+, K+, Li+, or NR4+, wherein R, which can be the same or different, represents hydrogen or an organic group such as a substituted or unsubstituted aryl and/or alkyl group.

As other examples, the organic group may include at least one geminal bisphosphonic acid group, partial esters thereof, or salts thereof. By “geminal”, it is meant that the at least two phosphonic acid groups, partial esters thereof, or salts thereof are directly bonded to the same carbon atom. Such a group may also be referred to as a 1,1-diphosphonic acid group, partial ester thereof, or salt thereof.

An example of a geminal bisphosphonic acid group may have the formula —CQ(PO3H2)2, or may be partial esters thereof or salts thereof. Q is bonded to the geminal position and may be H, R, OR, SR, or NR2 wherein R, which can be the same or different when multiple are present, is selected from H, a C1-C18 saturated or unsaturated, branched or unbranched alkyl group, a C1-C18 saturated or unsaturated, branched or unbranched acyl group, an aralkyl group, an alkaryl group, or an aryl group. For examples, Q may be H, R, OR, SR, or NR2, wherein R, which can be the same or different when multiple are present, is selected from H, a C1-C6 alkyl group, or an aryl group. As specific examples, Q is H, OH, or NH2. Another example of a geminal bisphosphonic acid group may have the formula —(CH2)nCQ(PO3H2)2, or may be partial esters thereof or salts thereof, wherein Q is as described above and n is 0 to 9, such as 1 to 9. In some specific examples, n is 0 to 3, such as 1 to 3, or n is either 0 or 1.

Still another example of a geminal bisphosphonic acid group may have the formula —X—(CH2)nCQ(PO3H2)2, or may be partial esters thereof or salts thereof, wherein Q and n are as described above and X is an arylene, heteroarylene, alkylene, vinylidene, alkarylene, aralkylene, cyclic, or heterocyclic group. In specific examples, X is an arylene group, such as a phenylene, naphthalene, or biphenylene group, which may be further substituted with any group, such as one or more alkyl groups or aryl groups. When X is an alkylene group, examples include substituted or unsubstituted alkylene groups, which may be branched or unbranched and can be substituted with one or more groups, such as aromatic groups. Examples of X include C1-C12 groups like methylene, ethylene, propylene, or butylene. X may be directly attached to the pigment, meaning there are no additional atoms or groups from the attached organic group between the pigment and X. X may also be further substituted with one or more functional groups. Examples of functional groups include R′, OR′, COR′, COOR′, OCOR′, carboxylates, halogens, CN, NR′2, SO3H, sulfonates, sulfates, NR′(COR′), CONR′2, imides, NO2, phosphates, phosphonates, N═NR′, SOR′, NR′SO2R′, and SO2NR′2, wherein R′, which can be the same or different when multiple are present, is independently selected from hydrogen, branched or unbranched C1-C20 substituted or unsubstituted, saturated or unsaturated hydrocarbons, e.g., alkyl, alkenyl, alkynyl, substituted or unsubstituted aryl, substituted or unsubstituted heteroaryl, substituted or unsubstituted alkaryl, or substituted or unsubstituted aralkyl.

Yet another example of a geminal bisphosphonic acid group may have the formula —X-Sp-(CH2)nCQ(PO3H2)2, or may be partial esters thereof or salt thereof, wherein X, Q, and n are as described above. “Sp” is a spacer group, which, as used herein, is a link between two groups. Sp can be a bond or a chemical group. Examples of chemical groups include, but are not limited to, —CO2-, —O2C—, —CO—, —OS2-, —SO3-, —SO2-, —SO2C2H4O—, —SO2C2H4S—, —SO2C2H4NR″—, —O—, —S—, —NR″—, —NR″CO—, —CONR″—, —NR″CO2-, —O2CNR″—, —NR″CONR″—, —N(COR″)CO—, —CON(COR″)—, —NR″COCH(CH2CO2R″)— and cyclic imides therefrom, —NR″COCH2CH(CO2R″)— and cyclic imides therefrom, —CH(CH2CO2R″)CONR″— and cyclic imides therefrom, —CH(CO2R″)CH2CONR″ and cyclic imides therefrom (including phthalimide and maleimides of these), sulfonamide groups (including —SO2NR″— and —NR″SO2- groups), arylene groups, alkylene groups and the like. R″, which can be the same or different when multiple are included, represents H or an organic group such as a substituted or unsubstituted aryl or alkyl group. In the example formula —X-Sp-(CH2)nCQ(PO3H2)2, the two phosphonic acid groups or partial esters or salts thereof are bonded to X through the spacer group Sp. Sp may be —CO2-, —O2C—, —O—, —NR″—, —NR″CO—, or —CONR″—, —SO2NR″—, —SO2CH2CH2NR″—, —SO2CH2CH2O—, or —SO2CH2CH2S— wherein R″ is H or a C1-C6 alkyl group.

Still a further example of a geminal bisphosphonic acid group may have the formula —N—[(CH2)m(PO3H2)]2, partial esters thereof, or salts thereof, wherein m, which can be the same or different, is 1 to 9. In specific examples, m is 1 to 3, or 1 or 2. As another example, the organic group may include at least one group having the formula —(CH2)n-N—[(CH2)m(PO3H2)]2, partial esters thereof, or salts thereof, wherein n is 0 to 9, such as 1 to 9, or 0 to 3, such as 1 to 3, and m is as defined above. Also, the organic group may include at least one group having the formula —X—(CH2)n-N—[(CH2)m(PO3H2)]2, partial esters thereof, or salts thereof, wherein X, m, and n are as described above, and, in an example, X is an arylene group. Still further, the organic group may include at least one group having the formula -X-Sp-(CH2)n-N—[(CH2)m(PO3H2)]2, partial esters thereof, or salts thereof, wherein X, m, n, and Sp are as described above.

Yet a further example of a geminal bisphosphonic acid group may have the formula —CR═C(PO3H2)2, partial esters thereof, or salts thereof. In this example, R can be H, a C1-C18 saturated or unsaturated, branched or unbranched alkyl group, a C1-C18 saturated or unsaturated, branched or unbranched acyl group, an aralkyl group, an alkaryl group, or an aryl group. In an example, R is H, a C1-C6 alkyl group, or an aryl group.

The organic group may also include more than two phosphonic acid groups, partial esters thereof, or salts thereof, and may, for example include more than one type of group (such as two or more) in which each type of group includes at least two phosphonic acid groups, partial esters thereof, or salts thereof. For example, the organic group may include a group having the formula —X—[CQ(PO3H2)2]P, partial esters thereof, or salts thereof. In this example, X and Q are as described above. In this formula, p is 1 to 4, e.g., 2.

In addition, the organic group may include at least one vicinal bisphosphonic acid group, partial ester thereof, or salts thereof, meaning that these groups are adjacent to each other. Thus, the organic group may include two phosphonic acid groups, partial esters thereof, or salts thereof bonded to adjacent or neighboring carbon atoms. Such groups are also sometimes referred to as 1,2-diphosphonic acid groups, partial esters thereof, or salts thereof. The organic group including the two phosphonic acid groups, partial esters thereof, or salts thereof may be an aromatic group or an alkyl group, and therefore the vicinal bisphosphonic acid group may be a vicinal alkyl or a vicinal aryl diphosphonic acid group, partial ester thereof, or salts thereof. For example, the organic group may be a group having the formula —C6H3-(PO3H2)2, partial esters thereof, or salts thereof, wherein the acid, ester, or salt groups are in positions ortho to each other.

In other examples, the ionic or ionizable group (of the organic group attached to the pigment) is a sulfur-containing group. The at least one sulfur-containing group has at least one S═O bond, such as a sulfinic acid group or a sulfonic acid group. Salts of sulfinic or sulfonic acids may also be used, such as —SO3-X+, where X is a cation, such as Na+, H+, K+, NH4+, Li+, Ca2+, Mg+, etc.

When the ionic or ionizable group is a carboxylic acid group, the group may be COOH or a salt thereof, such as —COO—X+, —(COO—X+)2, or —(COO—X+)3.

Examples of the self-dispersed color pigments are commercially available as dispersions. Suitable commercially available self-dispersed color pigment dispersions include those of the CAB-O-JET® 200 Series, manufactured by Cabot Corporation. Some specific examples include CAB-O-JET® 200 (black pigment), CAB-O-JET® 250C (cyan pigment), CAB-O-JET® 260M or 265M (magenta pigment) and CAB-O-JET® 270 (yellow pigment)). Other suitable commercially available self-dispersed pigment dispersions include those of the CAB-O-JET® 400 Series, manufactured by Cabot Corporation. Some specific examples include CAB-O-JET® 400 (black pigment), CAB-O-JET® 450C (cyan pigment), CAB-O-JET® 465M (magenta pigment) and CAB-O-JET® 470Y (yellow pigment)). Still other suitable commercially available self-dispersed pigment dispersions include those of the CAB-O-JET® 300 Series, manufactured by Cabot Corporation. Some specific examples include CAB-O-JET® 300 (black pigment) and CAB-O-JET® 352K (black pigment).

The self-dispersed color pigment may be present in an amount ranging from about 1 wt % active to about 10 wt % active based on a total weight of the colored pigmented inkjet ink. In an example, the self-dispersed color pigment is present in an amount ranging from about 1 wt % active to about 6 wt % active based on a total weight of the colored pigmented inkjet ink. In another example, the self-dispersed color pigment is present in an amount ranging from about 2 wt % active to about 5 wt % active based on a total weight of the colored pigmented inkjet ink. In yet another example, the self-dispersed color pigment is present in an amount of about 3 wt % based on the total weight of the colored pigmented inkjet ink. In still another example, the self-dispersed color pigment is present in an amount of about 5 wt % active based on the total weight of the colored pigmented inkjet ink.

Polymeric Binder

As mentioned above, in some examples, the colored pigmented inkjet ink includes a polymeric binder. Examples of the polymeric binder may be one of: a polyurethane-based binder selected from the group consisting of a polyester-polyurethane binder, a polyether-polyurethane binder, and a polycarbonate-polyurethane binder; or an acylic latex binder.

In an example, the colored pigmented inkjet ink includes the polyester-polyurethane binder. In an example, the polyester-polyurethane binder is a sulfonated polyester-polyurethane binder. The sulfonated polyester-polyurethane binder can include diaminesulfonate groups. In an example, the polymeric binder is the polyester-polyurethane binder, the polyester-polyurethane binder is a sulfonated polyester-polyurethane binder, and is one of: i) an aliphatic compound including multiple saturated carbon chain portions ranging from C₄ to C₁₀ in length, and that is devoid of an aromatic moiety, or ii) an aromatic compound including an aromatic moiety and multiple saturated carbon chain portions ranging from C₄ to C₁₀ in length.

In one example, the sulfonated polyester-polyurethane binder can be anionic. In further detail, the sulfonated polyester-polyurethane binder can also be aliphatic, including saturated carbon chains as part of the polymer backbone or as a side-chain thereof, e.g., C₂ to C₁₀, C₃ to C₈, or C₃ to C₆ alkyl. These polyester-polyurethane binders can be described as “alkyl” or “aliphatic” because these carbon chains are saturated and because they are devoid of aromatic moieties. An example of an anionic aliphatic polyester-polyurethane binder that can be used is IMPRANIL® DLN-SD (Mw 133,000; Acid Number 5.2; Tg −47° C.; Melting Point 175-200° C.) from Covestro. Example components used to prepare the IMPRANIL® DLN-SD or other similar anionic aliphatic polyester-polyurethane binders can include pentyl glycols (e.g., neopentyl glycol); C₄ to C₁₀ alkyldiol (e.g., hexane-1,6-diol); C₄ to C₁₀ alkyl dicarboxylic acids (e.g., adipic acid); C₄ to C₁₀ alkyl diisocyanates (e.g., hexamethylene diisocyanate (HDI)); diamine sulfonic acids (e.g., 2-[(2-aminoethyl)amino]ethanesulfonic acid); etc.

Alternatively, the sulfonated polyester-polyurethane binder can be aromatic (or include an aromatic moiety) and can include aliphatic chains. An example of an aromatic polyester-polyurethane binder that can be used is DISPERCOLL® U42. Example components used to prepare the DISPERCOLL® U42 or other similar aromatic polyester-polyurethane binders can include aromatic dicarboxylic acids, e.g., phthalic acid; C₄ to C₁₀ alkyl dialcohols (e.g., hexane-1,6-diol); C₄ to C₁₀ alkyl diisocyanates (e.g., hexamethylene diisocyanate (HDI)); diamine sulfonic acids (e.g., 2-[(2-am inoethyl)amino]ethanesulfonic acid); etc.

Other types of polyester-polyurethanes can also be used, including IMPRANIL® DL 1380, which can be somewhat more difficult to jet from thermal inkjet printheads compared to IMPRANIL® DLN-SD and DISPERCOLL® U42, but still can be acceptably jetted in some examples, and can also provide acceptable washfastness results on a variety of fabric types.

The polyester-polyurethane binders disclosed herein may have a weight average molecular weight ranging from about 20,000 to about 300,000. In some examples of the colored pigmented inkjet ink, the polymeric binder is the polyester-polyurethane binder, and the polyester-polyurethane binder has a weight average molecular weight ranging from about 20,000 to about 300,000. As examples, the weight average molecular weight can range from about 50,000 to about 500,000, from about 100,000 to about 400,000, or from about 150,000 to about 300,000.

The polyester-polyurethane binders disclosed herein may have an acid number that ranges from about 1 mg KOH/g to about 50 mg KOH/g. In some examples of the colored pigmented inkjet ink, the polymeric binder is the polyester-polyurethane binder, and the polyester-polyurethane binder has an acid number that ranges from about 1 mg KOH/g to about 50 mg KOH/g. As other examples, the acid number of the polyester-polyurethane binder can range from about 1 mg KOH/g to about 200 mg KOH/g, from about 2 mg KOH/g to about 100 mg KOH/g, or from about 3 mg KOH/g to about 50 mg KOH/g.

As used herein, the term “acid number” refers to the mass of potassium hydroxide (KOH) in milligrams that is used to neutralize one (1) gram of a particular substance. The test for determining the acid number of a particular substance may vary, depending on the substance. To determine the acid number of the polyester-polyurethane binder, a known amount of a sample of the polyester-polyurethane binder may be dispersed in water and the aqueous dispersion may be titrated with a polyelectrolyte titrant of a known concentration. In this example, a current detector for colloidal charge measurement may be used. An example of a current detector is the MUtek PCD-05 Smart Particle Charge Detector (available from BTG). The current detector measures colloidal substances in an aqueous sample by detecting the streaming potential as the sample is titrated with the polyelectrolyte titrant to the point of zero charge. An example of a suitable polyelectrolyte titrant is poly(diallyldimethylammonium chloride) (i.e., PolyDADMAC). It is to be understood that any suitable test for a particular component may be used.

The average particle size of the polyester-polyurethane binders disclosed herein may range from about 20 nm to about 500 nm. As examples, the sulfonated polyester-polyurethane binder can have an average particle size ranging from about 20 nm to about 500 nm, from about 50 nm to about 350 nm, or from about 100 nm to about 350 nm. As mentioned herein, the term “average particle size” may refer to a volume-weighted mean diameter of a particle distribution.

Other examples of the colored pigmented inkjet ink include a polyether-polyurethane binder. Examples of polyether-polyurethanes that may be used include IMPRANIL® LP DSB 1069, IMPRANIL® DLE, IMPRANIL® DAH, or IMPRANIL® DL 1116 (Covestro (Germany)); or HYDRAN® WLS-201 or HYDRAN® WLS-201K (DIC Corp. (Japan)); or TAKELAC® W-6061T or TAKELAC® WS-6021 (Mitsui (Japan)).

Still other examples of the colored pigmented inkjet ink include a polycarbonate-polyurethane binder. Examples of polycarbonate-polyurethanes that may be used as the polymeric binder include IMPRANIL® DLC-F or IMPRANIL® DL 2077 (Covestro (Germany)); or HYDRAN® WLS-213 (DIC Corp. (Japan)); or TAKELAC® W-6110 (Mitsui (Japan)).

Additional examples of the colored pigmented inkjet ink include an acrylic latex binder. The acrylic latex binder includes latex particles. As used herein, the term “latex” refers to a stable dispersion of polymer particles in an aqueous medium. As such, the polymer (latex) particles may be dispersed in water or water and a suitable co-solvent. This aqueous latex dispersion may be incorporated into a suitable ink vehicle to form examples of the colored pigmented inkjet ink.

In some examples, the latex particles can include a polymerization product of monomers including: a copolymerizable surfactant; an aromatic monomer selected from styrene, an aromatic (meth)acrylate monomer, and an aromatic (meth)acrylamide monomer; and multiple aliphatic (meth)acrylate monomers or multiple aliphatic (meth)acrylamide monomers. The term “(meth)” indicates that the acrylamide, the acrylate, etc., may or may not include the methyl group. In one example, the latex particles can include a polymerization product of a copolymerizable surfactant such as HITENOL™ BC-10, BC-30, KH-05, or KH-10. In another example, the latex particles can include a polymerization product of styrene, methyl methacrylate, butyl acrylate, and methacrylic acid.

In another particular example, the latex particles can include a first heteropolymer phase and a second heteropolymer phase. The first heteropolymer phase is a polymerization product of multiple aliphatic (meth)acrylate monomers or multiple aliphatic (meth)acrylamide monomers. The second heteropolymer phase can be a polymerization product of an aromatic monomer with a cycloaliphatic monomer, wherein the aromatic monomer is an aromatic (meth)acrylate monomer or an aromatic (meth)acrylamide monomer, and wherein the cycloaliphatic monomer is a cycloaliphatic (meth)acrylate monomer or a cycloaliphatic (meth)acrylamide monomer. The second heteropolymer phase can have a higher glass transition temperature than the first heteropolymer phase. The first heteropolymer composition may be considered a soft polymer composition and the second heteropolymers composition may be considered a hard polymer composition.

The two phases can be physically separated in the latex particles, such as in a core-shell configuration, a two-hemisphere configuration, smaller spheres of one phase distributed in a larger sphere of the other phase, interlocking strands of the two phases, and so on.

The first heteropolymer composition can be present in the latex particles in an amount ranging from about 15 wt % to about 70 wt % of a total weight of the polymer (latex) particle and the second heteropolymer composition can be present in an amount ranging from about 30 wt % to about 85 wt % of the total weight of the polymer particle. In other examples, the first heteropolymer composition can be present in an amount ranging from about 30 wt % to about 40 wt % of a total weight of the polymer particle and the second heteropolymer composition can be present in an amount ranging from about 60 wt % to about 70 wt % of the total weight of the polymer particle. In one specific example, the first heteropolymer composition can be present in an amount of about 35 wt % of a total weight of the polymer particle and the second heteropolymers composition can be present in an amount of about 65 wt % of the total weight of the polymer particle.

As mentioned herein, the first heteropolymer phase can be polymerized from two or more aliphatic (meth)acrylate ester monomers or two or more aliphatic (meth)acrylamide monomers. The aliphatic (meth)acrylate ester monomers may be linear aliphatic (meth)acrylate ester monomers and/or cycloaliphatic (meth)acrylate ester monomers. Examples of the linear aliphatic (meth)acrylate ester monomers can include ethyl acrylate, ethyl methacrylate, benzyl acrylate, benzyl methacrylate, propyl acrylate, propyl methacrylate, isopropyl acrylate, isopropyl methacrylate, butyl acrylate, butyl methacrylate, isobutyl acrylate, isobutyl methacrylate, hexyl acrylate, hexyl methacrylate, isooctyl acrylate, isooctyl methacrylate, octadecyl acrylate, octadecyl methacrylate, lauryl acrylate, lauryl methacrylate, hydroxyethyl acrylate, hydroxyethyl methacrylate, hydroxyhexyl acrylate, hydroxyhexyl methacrylate, hydroxyoctadecyl acrylate, hydroxyoctadecyl methacrylate, hydroxylauryl methacrylate, hydroxylauryl acrylate, 2-ethylhexyl acrylate, 2-ethylhexyl methacrylate, and combinations thereof. Examples of the cycloaliphatic (meth)acrylate ester monomers can include cyclohexyl acrylate, cyclohexyl methacrylate, methylcyclohexyl acrylate, methylcyclohexyl methacrylate, trimethylcyclohexyl acrylate, trimethylcyclohexyl methacrylate, tert-butylcyclohexyl acrylate, tert-butylcyclohexyl methacrylate, and combinations thereof.

Also as mentioned herein, the second heteropolymer phase can be polymerized from a cycloaliphatic monomer and an aromatic monomer. The cycloaliphatic monomer can be a cycloaliphatic (meth)acrylate monomer or a cycloaliphatic (meth)acrylamide monomer. The aromatic monomer can be an aromatic (meth)acrylate monomer or an aromatic (meth)acrylamide monomer. The cycloaliphatic monomer of the second heteropolymer phase can be cyclohexyl acrylate, cyclohexyl methacrylate, methylcyclohexyl acrylate, methylcyclohexyl methacrylate, trimethylcyclohexyl acrylate, trimethylcyclohexyl methacrylate, tert-butylcyclohexyl acrylate, tert-butylcyclohexyl methacrylate, or a combination thereof. In still further examples, the aromatic monomer of the second heteropolymer phase can be 2-phenoxyethyl methacrylate, 2-phenoxyethyl acrylate, phenyl propyl methacrylate, phenyl propyl acrylate, benzyl methacrylate, benzyl acrylate, phenylethyl methacrylate, phenylethyl acrylate, benzhydryl methacrylate, benzhydryl acrylate, 2-hydroxy-3-phenoxypropyl acrylate, 2-hydroxy-3-phenoxypropyl methacrylate, N-benzyl methacrylamide, N-benzyl acrylamide, N,N-diphenyl methacrylamide, N,N-diphenyl acrylamide, naphthyl methacrylate, naphthyl acrylate, phenyl methacrylate, phenyl acrylate, or a combination thereof.

The latex particles can have a particle size ranging from 20 nm to 500 nm, from 50 nm to 350 nm, or from 150 nm to 270 nm.

In some examples, the latex particles can be prepared by flowing multiple monomer streams into a reactor. An initiator can also be included in the reactor. The initiator may be selected from a persulfate, such as a metal persulfate or an ammonium persulfate. In some examples, the initiator may be selected from a sodium persulfate, ammonium persulfate or potassium persulfate. The preparation process may be performed in water, resulting in the aqueous latex dispersion.

In some examples of the colored pigmented inkjet ink, the polymeric binder is present in an amount ranging from about 2 wt % active to about 15 wt % active, based on a total weight of the colored pigmented inkjet ink. In other examples, the polymeric binder can be present, in the colored pigmented inkjet ink, in an amount ranging from about from about 3 wt % active to about 11 wt % active, or from about 4 wt % active to about 10 wt % active, or from about 5 wt % active to about 9 wt % active, each of which is based on the total weight of the colored pigmented inkjet ink.

The polymeric binder (prior to being incorporated into the colored pigmented inkjet ink) may be dispersed in water alone or in combination with an additional water soluble or water miscible co-solvent, such as those described for the color pigment dispersion. It is to be understood however, that the liquid components of the binder dispersion become part of the liquid vehicle in the colored pigmented inkjet ink.

Colored Pigmented Inkjet Ink Vehicle

In addition to the color pigment (and in some instances the polymeric binder), the colored pigmented inkjet ink includes a colored pigmented inkjet ink vehicle.

As used herein, the term “colored pigmented inkjet ink vehicle” may refer to the liquid with which the color pigment (dispersion) and/or the polymeric binder (dispersion) are mixed to form a thermal or a piezoelectric inkjet ink(s) composition. A wide variety of vehicles may be used with the ink composition(s) of the present disclosure. The colored pigmented inkjet ink vehicle may include water and a co-solvent and any of: a surfactant, an anti-decel agent, an anti-kogation agent, an antimicrobial agent, a pH adjuster, or combinations thereof. In an example of the colored pigmented inkjet ink, the vehicle includes water and a co-solvent. In another example, the vehicle consists of water and the co-solvent, the surfactant, the anti-decel agent, the anti-kogation agent, the antimicrobial agent, the pH adjuster, or a combination thereof.

The co-solvent in the colored pigmented inkjet ink may be any example of the water-soluble organic solvents set forth herein for the dye discharge fluid, in any amount set forth herein for the dye discharge fluid (except that the amount(s) are based on the total weight of the colored pigmented inkjet ink instead of the dye discharge fluid).

The surfactant in the colored pigmented inkjet ink may be an anionic surfactant or a non-ionic surfactant.

Examples of the anionic surfactant may include alkylbenzene sulfonate, alkylphenyl sulfonate, alkylnaphthalene sulfonate, higher fatty acid salt, sulfate ester salt of higher fatty acid ester, sulfonate of higher fatty acid ester, sulfate ester salt and sulfonate of higher alcohol ether, higher alkyl sulfosuccinate, polyoxyethylene alkylether carboxylate, polyoxyethylene alkylether sulfate, alkyl phosphate, and polyoxyethylene alkyl ether phosphate. Specific examples of the anionic surfactant may include dodecylbenzenesulfonate, isopropylnaphthalenesulfonate, monobutylphenylphenol monosulfonate, monobutylbiphenyl sulfonate, monobutylbiphenylsul fonate, and dibutylphenylphenol disulfonate.

Any example of the non-ionic surfactants set forth herein for the dye discharge fluid may be used as the surfactant in the colored pigmented inkjet ink.

The surfactant may be present in the colored pigmented inkjet ink in an amount ranging from about 0.01 wt % active to about 5 wt % active (based on the total weight of the colored pigmented inkjet ink). In an example, the surfactant is present in the colored pigmented inkjet ink in an amount ranging from about 0.05 wt % active to about 3 wt % active, based on the total weight of the colored pigmented inkjet ink.

The anti-decel agent in the colored pigmented inkjet ink may be any example of the anti-decel agent set forth herein for the dye discharge fluid, in any amount set forth herein for the dye discharge fluid (except that the amount(s) are based on the total weight of the colored pigmented inkjet ink instead of the dye discharge fluid).

An anti-kogation agent may also be included in the vehicle of the colored pigmented inkjet ink, for example, when the colored pigmented inkjet ink is to be applied via a thermal inkjet printhead. Anti-kogation agent(s) is/are included to assist in preventing the buildup of kogation. In some examples, the anti-kogation agent may improve the jettability of the colored pigmented inkjet ink. The anti-kogation agent may be present in the colored pigmented inkjet ink in an amount ranging from about 0.1 wt % active to about 1.5 wt % active, based on the total weight of the colored pigmented inkjet ink. In an example, the anti-kogation agent is present in an amount of about 0.5 wt % active, based on the total weight of the colored pigmented inkjet ink.

Examples of suitable anti-kogation agents include oleth-3-phosphate (commercially available as CRODAFOS™ O3 A or CRODAFOS™ N-3A) or dextran 500 k. Other suitable examples of the anti-kogation agents include CRODAFOS™ HCE (phosphate-ester from Croda Int.), CRODAFOS® N10 (oleth-10-phosphate from Croda Int.), or DISPERSOGEN® LFH (polymeric dispersing agent with aromatic anchoring groups, acid form, anionic, from Clariant), etc. It is to be understood that any combination of the anti-kogation agents listed may be used.

The vehicle of the colored pigmented inkjet ink may also include antimicrobial agent(s). In an example, the total amount of antimicrobial agent(s) in the colored pigmented inkjet ink ranges from about 0.01 wt % active to about 0.05 wt % active (based on the total weight of the colored pigmented inkjet ink). In another example, the total amount of antimicrobial agent(s) in the colored pigmented inkjet ink is about 0.044 wt % active (based on the total weight of the colored pigmented inkjet ink). Examples of suitable antimicrobial agents include any of those listed herein for the dye discharge fluid.

The ink vehicle of the colored pigmented inkjet ink may also include a pH adjuster. A pH adjuster may be included in the colored pigmented inkjet ink to achieve a desired pH of greater than 7. Suitable pH ranges for examples of colored pigmented inkjet ink can be from greater than pH 7 to pH 11, from greater than pH 7 to pH 10, from pH 7.2 to pH 10, from pH 7.5 to pH 10, from pH 8 to pH 10, 7 to pH 9, from pH 7.2 to pH 9, from pH 7.5 to pH 9, from pH 8 to pH 9, from 7 to pH 8.5, from pH 7.2 to pH 8.5, from pH 7.5 to pH 8.5, from pH 8 to pH 8.5, from 7 to pH 8, from pH 7.2 to pH 8, or from pH 7.5 to pH 8.

The type and amount of pH adjuster that is added to the colored pigmented inkjet ink may depend upon the initial pH of the colored pigmented inkjet ink and the desired final pH of the colored pigmented inkjet ink. If the initial pH is too high, an acid may be added to lower the pH, and if the initial pH is too low, a base may be added increase the pH. Examples of suitable pH adjusters include metal hydroxide bases, such as potassium hydroxide (KOH), sodium hydroxide (NaOH), etc. In an example, the metal hydroxide base may be added to the colored pigmented inkjet ink in an aqueous solution. In another example, the metal hydroxide base may be added to the colored pigmented inkjet ink in an aqueous solution including 5 wt % of the metal hydroxide base (e.g., a 5 wt % potassium hydroxide aqueous solution).

In an example, the total amount of pH adjuster(s) in the colored pigmented inkjet ink ranges from greater than 0 wt % to about 0.1 wt % (based on the total weight of the colored pigmented inkjet ink). In another example, the total amount of pH adjuster(s) in the colored pigmented inkjet ink is about 0.03 wt % (based on the total weight of the colored pigmented inkjet ink).

In some instances, other suitable inkjet ink additives may be included in the colored pigmented inkjet ink, such as chelating/sequestering agents (e.g., EDTA (ethylenediaminetetraacetic acid) to eliminate the deleterious effects of heavy metal impurities, and viscosity modifiers to modify properties of the ink as desired.

The balance of the colored pigmented inkjet ink is water. In an example, purified water or deionized water may be used. The water included in the colored pigmented inkjet ink may be: i) part of the color pigment dispersion, and/or binder dispersion, ii) part of the colored pigmented inkjet ink vehicle, iii) added to a mixture of the color pigment dispersion, and/or binder dispersion and the colored pigmented inkjet ink vehicle, or iv) a combination thereof. In examples where the colored pigmented inkjet ink is a thermal inkjet ink, the liquid vehicle includes at least 70% by weight of water. In examples where the colored pigmented inkjet ink is a piezoelectric inkjet ink, the liquid vehicle is a solvent based vehicle including at least 50% by weight of the co-solvent.

White Pigmented Inkjet Inks

Examples of the white pigmented inkjet ink disclosed herein will now be described. Examples of the white pigmented inkjet ink include a white pigment, a co-solvent, and a balance of water. In some examples, the white pigmented inkjet ink consists of the white pigment, the co-solvent, and the balance of water. In other examples, the white pigmented inkjet ink may include additional components, such as a polymeric binder, a surfactant, an anti-decel agent, an anti-kogation agent, an antimicrobial agent, a pH adjuster, or combinations thereof.

Examples of the white pigmented inkjet ink disclosed herein may be used in a thermal inkjet printer or in a piezoelectric printer to print on a textile fabric. The viscosity of the white pigmented inkjet ink may be adjusted for the type of printhead that is to be used, and the viscosity may be adjusted by adjusting the co-solvent level, adjusting the polymeric binder level, and/or adding a viscosity modifier. When used in a thermal inkjet printer, the viscosity of the white pigmented inkjet ink may be modified to range from about 1 cP to about 9 cP (at 20° C. to 25° C.), and when used in a piezoelectric printer, the viscosity of the white pigmented inkjet ink may be modified to range from about 1 cP to about 20 cP (at 20° C. to 25° C.), depending on the type of the printhead that is being used (e.g., low viscosity printheads, medium viscosity printheads, or high viscosity printheads).

White Pigments

The white pigment is resistant to discoloration by the dye discharge fluid. In other words, the white pigment either (i) does not become reduced in the presence of the activated reducing agent of the discharge fluid or (ii) does not change color when reduced in the presence of the activated reducing agent of the discharge fluid.

The white pigment may be incorporated into the white pigmented inkjet ink as a white pigment dispersion. The white pigment dispersion may include a white pigment and a separate pigment dispersant.

For the white pigment dispersions disclosed herein, it is to be understood that the white pigment and separate pigment dispersant (prior to being incorporated into the ink formulation), may be dispersed in water alone or in combination with an additional water soluble or water miscible co-solvent, such as 2-pyrrolidone, 1-(2-hydroxyethyl)-2-pyrrolidone, glycerol, 2-methyl-1,3-propanediol, 1,2-butane diol, diethylene glycol, triethylene glycol, tetraethylene glycol, or a combination thereof. It is to be understood however, that the liquid components of the white pigment dispersion become part of the liquid vehicle in the white pigmented inkjet ink.

Examples of suitable white pigments include white metal oxide pigments, such as titanium dioxide (TiO₂), zinc oxide (ZnO), zirconium dioxide (ZrO₂), or the like. In one example, the white pigment is titanium dioxide. In an example, the titanium dioxide is in its rutile form.

In some examples, the white pigment may include white metal oxide pigment particles coated with silicon dioxide (SiO₂). In one example, the white metal oxide pigment content to silicon dioxide content can be from 100:3.5 to 5:1 by weight. In other examples, the white pigment may include white metal oxide pigment particles coated with silicon dioxide (SiO₂) and aluminum oxide (Al₂O₃). In one example, the white metal oxide pigment content to total silicon dioxide and aluminum oxide content can be from 50:3 to 4:1 by weight. One example of the white pigment includes TI-PURE® R960 (TiO₂ pigment powder with 5.5 wt % silica and 3.3 wt % alumina (based on pigment content)) available from Chemours. Another example of the white pigment includes TI-PURE® R931 (TiO₂ pigment powder with 10.2 wt % silica and 6.4 wt % alumina (based on pigment content)) available from Chemours. Still another example of the white pigment includes TI-PURE® R706 (TiO₂ pigment powder with 3.0 wt % silica and 2.5 wt % alumina (based on pigment content)) available from Chemours.

The white pigment may have high light scattering capabilities, and the average particle size of the white pigment may be selected to enhance light scattering and lower transmittance, thus increasing opacity. The average particle size of the white pigment may range anywhere from about 100 nm to about 2000 nm. In some examples, the average particle size ranges from about 120 nm to about 2000 nm, from about 150 nm to about 1000 nm, from about 150 nm to about 750 nm, or from about 200 nm to about 500 nm. As mentioned, the term “average particle size”, as used herein, may refer to a volume-weighted mean diameter of a particle distribution.

In an example, the white pigment is present in an amount ranging from about 3 wt % active to about 20 wt % active, based on a total weight of the white pigmented inkjet ink. In other examples, the white pigment is present in an amount ranging from about 5 wt % active to about 20 wt % active, or from about 5 wt % active to about 15 wt % active, based on a total weight of the white pigmented inkjet ink. In still another example, the white pigment is present in an amount of about 10 wt % active or about 9.75 wt % active, based on a total weight of the white pigmented inkjet ink.

Pigment Dispersants

The white pigment may be dispersed with the pigment dispersant. In an example, the pigment dispersant is selected from the group consisting of a water-soluble acrylic acid polymer, a branched co-polymer of a comb-type structure with polyether pendant chains and acidic anchor groups attached to a backbone, and a combination thereof.

Some examples of the water-soluble acrylic acid polymer include CARBOSPERSE® K7028 (polyacrylic acid having a weight average molecular weight (Mw) of about 2,300), CARBOSPERSE® K752 (polyacrylic acid having a weight average molecular weight (Mw) of about 2,000), CARBOSPERSE® K7058 (polyacrylic acid having a weight average molecular weight (Mw) of about 7,300), and CARBOSPERSE® K732 (polyacrylic acid having a weight average molecular weight (Mw) of about 6,000), all available from Lubrizol Corporation.

Some examples of the branched co-polymer of the comb-type structure with polyether pendant chains and acidic anchor groups attached to the backbone include DISPERBYK®-190 (an acid number of about 10 mg KOH/g) and DISPERBYK®-199, both available from BYK Additives and Instruments, as well as DISPERSOGEN® PCE available from Clariant.

In some examples, the pigment dispersant is present in an amount ranging from about 0.05 wt % active to about 1 wt % active, based on a total weight of the white pigmented inkjet ink. In one of these examples, the dispersant is present in an amount of about 0.23 wt % active, based on a total weight of the white pigmented inkjet ink.

In some examples, the pigment dispersant includes both the water-soluble acrylic acid polymer and the branched co-polymer of the comb-type structure with polyether pendant chains and acidic anchor groups attached to the backbone. In some of these examples, the pigment dispersant includes CARBOSPERSE® K7028 and DISPERBYK®-190. In some of these examples, the pigment dispersant includes both the water-soluble acrylic acid polymer and the branched co-polymer of the comb-type structure with polyether pendant chains and acidic anchor groups attached to the backbone, where the water-soluble acrylic acid polymer is present in an amount ranging from about 0.02 wt % active to about 0.4 wt % active, and the branched co-polymer of the comb-type structure with polyether pendant chains and acidic anchor groups attached to the backbone is present in an amount ranging from about 0.03 wt % active to about 0.6 wt % active. In one of these examples, the water-soluble acrylic acid polymer is present in an amount of about 0.09 wt % active, and the branched co-polymer of the comb-type structure with polyether pendant chains and acidic anchor groups attached to the backbone is present in an amount of about 0.14 wt % active.

Polymeric Binder

As mentioned above, in some examples, the white pigmented inkjet ink includes a polymeric binder. The polymeric binder in the white pigmented inkjet ink may be any example of the polymeric binder set forth herein for the colored pigmented inkjet ink, in any amount set forth herein for the colored pigmented inkjet ink (except that the amount(s) are based on the total weight of the white pigmented inkjet ink instead of the colored pigmented inkjet ink).

The polymeric binder (prior to being incorporated into the white pigmented inkjet ink) may be dispersed in water alone or in combination with an additional water soluble or water miscible co-solvent, such as those described for the white pigment dispersion. It is to be understood however, that the liquid components of the binder dispersion become part of the liquid vehicle in the white pigmented inkjet ink.

White Pigmented Inkjet Ink Vehicle

In addition to the white pigment (and in some instances the polymeric binder), the white pigmented inkjet ink includes a white pigmented inkjet ink vehicle.

As used herein, the term “white pigmented inkjet ink vehicle” may refer to the liquid with which the white pigment (dispersion) and/or the polymeric binder (dispersion) are mixed to form a thermal or a piezoelectric inkjet ink(s) composition. A wide variety of vehicles may be used with the ink composition(s) of the present disclosure. The white pigmented inkjet ink vehicle may include water and any of: a co-solvent, a surfactant, an anti-decel agent, an anti-kogation agent, an antimicrobial agent, a pH adjuster, or combinations thereof. In an example of the white pigmented inkjet ink, the vehicle includes water and a co-solvent. In another example, the vehicle consists of water and the co-solvent, the surfactant, the anti-decel agent, the anti-kogation agent, the antimicrobial agent, the pH adjuster, or a combination thereof. In still another example, the ink vehicle consists of the surfactant, the anti-decel agent, the anti-kogation agent, the antimicrobial agent, the pH adjuster, and water.

The co-solvent in the white pigmented inkjet ink may be any example of the water-soluble organic solvents set forth herein for the dye discharge fluid, in any amount set forth herein for the dye discharge fluid (except that the amount(s) are based on the total weight of the white pigmented inkjet ink instead of the dye discharge fluid).

The surfactant in the white pigmented inkjet ink may be any example of the anionic or non-ionic surfactants set forth herein for the colored pigmented inkjet ink, in any amount set forth herein for the colored pigmented inkjet ink (except that the amount(s) are based on the total weight of the white pigmented inkjet ink instead of the colored pigmented inkjet ink).

The anti-decel agent in the white pigmented inkjet ink may be any example of the anti-decel agent set forth herein for the dye discharge fluid, in any amount set forth herein for the dye discharge fluid (except that the amount(s) are based on the total weight of the white pigmented inkjet ink instead of the dye discharge fluid).

The anti-kogation agent in the white pigmented inkjet ink may be any example of the anti-kogation agent set forth herein for the colored pigmented inkjet ink, in any amount set forth herein for the colored pigmented inkjet ink (except that the amount(s) are based on the total weight of the white pigmented inkjet ink instead of the colored pigmented inkjet ink).

The antimicrobial agent in the white pigmented inkjet ink may be any example of the antimicrobial agent set forth herein for the colored pigmented inkjet ink, in any amount set forth herein for the colored pigmented inkjet ink (except that the amount(s) are based on the total weight of the white pigmented inkjet ink instead of the colored pigmented inkjet ink).

The ink vehicle of the white pigmented inkjet ink may also include a pH adjuster. A pH adjuster may be included in the white pigmented inkjet ink to achieve a desired pH of greater than 7. Suitable pH ranges for examples of white pigmented inkjet ink can be from greater than pH 7 to pH 11, from greater than pH 7 to pH 10, from pH 7.2 to pH 10, from pH 7.5 to pH 10, from pH 8 to pH 10, 7 to pH 9, from pH 7.2 to pH 9, from pH 7.5 to pH 9, from pH 8 to pH 9, from 7 to pH 8.5, from pH 7.2 to pH 8.5, from pH 7.5 to pH 8.5, from pH 8 to pH 8.5, from 7 to pH 8, from pH 7.2 to pH 8, or from pH 7.5 to pH 8.

The pH adjuster in the white pigmented inkjet ink may be any example of the pH adjuster set forth herein for the colored pigmented inkjet ink, in any amount set forth herein for the colored pigmented inkjet ink (except that the amount(s) are based on the total weight of the white pigmented inkjet ink instead of the colored pigmented inkjet ink).

In some instances, other suitable inkjet ink additives may be included in the white pigmented inkjet ink, such as chelating/sequestering agents (e.g., EDTA (ethylenediaminetetraacetic acid) to eliminate the deleterious effects of heavy metal impurities, and viscosity modifiers to modify properties of the ink as desired.

The balance of the white pigmented inkjet ink is water. In an example, purified water or deionized water may be used. The water included in the white pigmented inkjet ink may be: i) part of the white pigment dispersion, and/or binder dispersion, ii) part of the white pigmented inkjet ink vehicle, iii) added to a mixture of the white pigment dispersion, and/or binder dispersion and the white pigmented inkjet ink vehicle, or iv) a combination thereof. In examples where the white pigmented inkjet ink is a thermal inkjet ink, the liquid vehicle includes at least 70% by weight of water. In examples where the white pigmented inkjet ink is a piezoelectric inkjet ink, the liquid vehicle is a solvent based vehicle including at least 50% by weight of the co-solvent.

Fluid Sets

The dye discharge fluid disclosed herein may be included in a fluid set.

In some examples, the fluid set includes or consists of the dye discharge fluid and the colored pigmented inkjet ink. In one of these examples, the fluid set includes: the dye discharge fluid including: a water-soluble organic solvent; a heat activated reducing agent; and water; wherein a pH of the dye discharge fluid is less than 7; and the colored pigmented inkjet ink including: a color pigment; a co-solvent; and a balance of water.

In other examples, the fluid set includes or consists of the dye discharge fluid and the white pigmented inkjet ink. In one of these examples, the fluid set includes: the dye discharge fluid including: a water-soluble organic solvent; a heat activated reducing agent; and water; wherein a pH of the dye discharge fluid is less than 7; and the white pigmented inkjet ink including: a white pigment; a co-solvent; and a balance of water.

In still other examples, the fluid set includes or consists of the dye discharge fluid, the colored pigmented inkjet ink, and the white pigmented inkjet ink. In one of these examples, the fluid set includes: the dye discharge fluid including: a water-soluble organic solvent; a heat activated reducing agent; and water; wherein a pH of the dye discharge fluid is less than 7; the colored pigmented inkjet ink including: a color pigment; a co-solvent; and a balance of water; and the white pigmented inkjet ink including: a white pigment; another co-solvent; and a balance of water.

It is to be understood that any example of the dye discharge fluid, any example of the colored pigmented inkjet ink, and/or any example of the white pigmented inkjet ink may be used in the examples of the fluid set. Further, it is be understood that multiple dye discharge fluids, multiple colored pigmented inkjet inks, and/or multiple white pigmented inkjet inks may be used in the examples of the fluid set.

Colored Textile Fabrics

In the examples disclosed herein, the colored textile fabric may be a textile fabric that is colored with a reactive dye (e.g., an azo dye and/or an anthraquinone dye).

In an example, the colored textile fabric is a colored cotton-based textile fabric. In a further example, the colored textile fabric is selected from the group consisting of colored cotton fabrics and colored cotton blend fabrics. Colored cotton blends may include colored cotton in combination with one or more other material(s). One example of a colored cotton blend is a colored polyester-cotton blend. An example of a colored tri-blend includes colored cotton, polyester, and spandex. It is to be understood that, in these examples, the colored cotton-based textile fabric, the colored cotton fabric, or the colored cotton blend fabric is colored with the reactive dye (e.g., an azo dye and/or an anthraquinone dye).

It is to be understood that organic textile fabrics and/or inorganic textile fabrics may be used for the colored textile fabric. Some types of fabrics that can be used include various fabrics of natural fibers.

Example natural fiber fabrics that can be used in colored cotton or colored cotton blends include treated or untreated natural fabric textile substrates, e.g., cotton, alone or in combination with wool, silk, linen, jute, flax, hemp, rayon fibers, thermoplastic aliphatic polymeric fibers derived from renewable resources (e.g. cornstarch, tapioca products, sugarcanes), etc. In an example, cotton and another natural fiber may be combined at ratios of 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa.

The colored textile fabric includes the reactive dye. The reactive dye (prior to reduction by the activated reducing agent) causes the textile fabric to be colored. In some examples, the reactive dye may be an azo dye, an anthraquinone dye, or a combination thereof. In these examples, the colored textile fabric includes the azo dye, the anthraquinone dye, or the combination thereof.

The colored textile fabric may be any non-white color. In some examples, the colored textile fabric may be black, red, blue, orange, purple, green, brown, etc. In one example, the colored textile fabric is a black colored textile fabric. In another example, the colored textile fabric is a red colored textile fabric.

In addition to the fibers and the reactive dye, the colored textile fabric may contain additives, such as an antistatic agent, a brightening agent, a nucleating agent, an antioxidant, a UV stabilizer, a filler, and/or a lubricant, for example.

It is to be understood that the terms “colored textile fabric,” “colored fabric substrate,” “textile fabric,” or “fabric substrate” do not include materials commonly known as any kind of paper (even though paper can include multiple types of natural fibers or mixtures of natural and synthetic fibers). Colored textile fabrics can include textiles in filament form, textiles in the form of fabric material, or textiles in the form of fabric that has been crafted into finished articles (e.g., clothing, blankets, tablecloths, napkins, towels, bedding material, curtains, carpet, handbags, shoes, banners, signs, flags, etc.). In some examples, the colored textile fabric can have a woven, knitted, non-woven, or tufted fabric structure. In one example, the colored textile fabric can be a woven fabric where warp yarns and weft yarns can be mutually positioned at an angle of about 90°. This woven fabric can include fabric with a plain weave structure, fabric with twill weave structure where the twill weave produces diagonal lines on a face of the fabric, or a satin weave. In another example, the colored textile fabric can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the colored textile fabric can be a non-woven fabric. For example, the non-woven fabric can be a flexible fabric that can include a plurality of fibers or filaments that are one or both bonded together and interlocked together by a chemical treatment process (e.g., a solvent treatment), a mechanical treatment process (e.g., embossing), a thermal treatment process, or a combination of multiple processes.

In one example, the colored textile fabric can have a basis weight ranging from 10 gsm to 500 gsm. In another example, the colored textile fabric can have a basis weight ranging from 50 gsm to 400 gsm. In other examples, the colored textile fabric can have a basis weight ranging from 100 gsm to 300 gsm, from 75 gsm to 250 gsm, from 125 gsm to 300 gsm, or from 150 gsm to 350 gsm.

Textile Printing Kits

The colored textile fabric and the dye discharge fluid disclosed herein may be included in a printing kit.

In an example, the printing kit comprises: a colored textile fabric; and a dye discharge fluid including: a water-soluble organic solvent; a heat activated reducing agent; and water; wherein a pH of the dye discharge fluid is less than 7. In another example, the printing kit consists of the colored textile fabric and the dye discharge fluid.

In some examples, the printing kit further comprises: a colored pigmented inkjet ink including: a color pigment; a co-solvent; and a balance of water. In one of these examples, the printing kit consists of the colored textile fabric, the dye discharge fluid, and the colored pigmented inkjet ink.

In some examples, the printing kit further comprises: a white pigmented inkjet ink including: a white pigment; a co-solvent; and a balance of water. In one of these examples, the printing kit consists of the colored textile fabric, the dye discharge fluid, and the white pigmented inkjet ink.

In some examples, the printing kit further comprises: a colored pigmented inkjet ink including: a color pigment; a co-solvent; and a balance of water; and a white pigmented inkjet ink including: a white pigment; another co-solvent; and a balance of water. In one of these examples, the printing kit consists of the colored textile fabric, the dye discharge fluid, the colored pigmented inkjet ink, and the white pigmented inkjet ink.

It is to be understood that any example of the colored textile fabric, any example of the dye discharge fluid, any example of the colored pigmented inkjet ink, and/or any example of the white pigmented inkjet ink may be used in the examples of the printing kit. Further, it is be understood that multiple colored textile fabrics, multiple dye discharge fluids, multiple colored pigmented inkjet inks, and/or multiple white pigmented inkjet inks may be used in the examples of the printing kit.

Printing Method and System

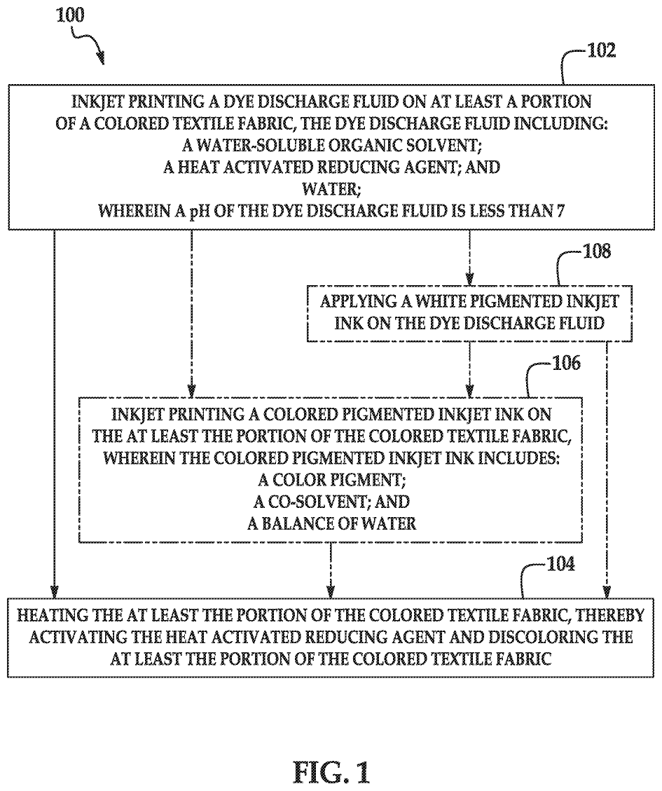

FIG. 1 depicts several examples of the printing method 100. It is to be understood that any example of the colored textile fabric, any example of the dye discharge fluid, any example of the colored pigmented inkjet ink, and/or any example of the white pigmented inkjet ink may be used in the examples of the printing method 100.

As shown in FIG. 1, some examples of the printing method 100 comprises: inkjet printing a dye discharge fluid on at least a portion of a colored textile fabric, the dye discharge fluid including: a water-soluble organic solvent; a heat activated reducing agent; and water; wherein a pH of the dye discharge fluid is less than 7 (reference numeral 102); and heating the at least the portion of the colored textile fabric, thereby activating the heat activated reducing agent and discoloring the at least the portion of the colored textile fabric (reference numeral 104).

In some of these examples, the dye discharge fluid alone is applied on the portion of the colored textile fabric, and no ink is applied on the portion of the colored textile fabric. In these examples, the dye discharge fluid may be used to generate a lighter image on the colored textile fabric.

Also as shown in FIG. 1, in some examples of the printing method 100, prior to the heating, the method 100 further comprises inkjet printing a colored pigmented inkjet ink on the at least the portion of the colored textile fabric, wherein the colored pigmented inkjet ink includes: a color pigment; a co-solvent; and a balance of water (reference numeral 106). In these examples, the dye discharge fluid may be used to whiten or lighten an area of the textile fabric where the colored pigmented inkjet ink(s) will be deposited to form the image.

In some of these examples, the colored pigmented inkjet ink is printed directly on the dye discharge fluid that has been dispensed on the colored textile fabric. In one example, the colored pigmented inkjet ink is printed on the dye discharge fluid before the dye discharge fluid is exposed to heating. In another example, the colored pigmented inkjet ink is printed on the dye discharge fluid after the dye discharge fluid is exposed to heating. In these examples, the dye discharge fluid creates a lightened area of the colored textile fabric that enables the colored pigmented inkjet ink(s) to be visible on the textile fabric without a white ink underbase.

Also as shown in FIG. 1, in some examples, the printing method 100 comprises applying a white pigmented inkjet ink on the dye discharge fluid (reference numeral 108).

In some of these examples, the printing method 100 further comprises applying the white pigmented inkjet ink on the dye discharge fluid prior to printing the colored pigmented inkjet ink. In these examples, the dye discharge fluid may reduce the amount of white ink that is printed prior to the deposition of the colored pigmented inkjet ink(s). The reduced amount of white ink may be relative to the amount of white ink that would be used to achieve the same visibility and/or shade of the colored pigmented inkjet ink(s) if the dye discharge fluid was not used.

In others of these examples, the white pigmented inkjet ink may be applied on the dye discharge fluid without applying any colored pigmented inkjet ink. In these examples, the resulting image may be white, and the dye discharge fluid may reduce the amount of white ink used to form the white image. The reduced amount of white ink may be relative to the amount of white ink that would be used to achieve the same opacity of the white ink layer (white image) if the dye discharge fluid was not used.

As shown in reference numeral 102 in FIG. 1, the printing method 100 includes inkjet printing the dye discharge fluid on at least a portion of the colored textile fabric. As also shown in reference numeral 108 and reference numeral 106, some examples of the printing method 100 also include applying the white pigmented inkjet ink and/or inkjet printing the colored pigmented inkjet ink on the at least the portion of the colored textile fabric.

In some examples, the dye discharge fluid is applied in an amount ranging from about 5 gsm to about 100 gsm. In one example, the dye discharge fluid is applied in an amount of about 20 gsm or about 40 gsm.

In some examples, the white pigmented inkjet ink is applied in an amount ranging from about 100 gsm to about 400 gsm. In some examples, the white pigmented inkjet ink is applied in an amount ranging from about 125 gsm to about 350 gsm. In one example, the white pigmented inkjet ink is applied in an amount of about 150 gsm.

In some examples, the colored pigmented inkjet ink is applied in an amount ranging from about 5 gsm to about 80 gsm. In one example, the colored pigmented inkjet ink is applied in an amount of about 20 gsm, or about 40 gsm.

In some examples, the dye discharge fluid, the white pigmented inkjet ink, and/or the colored pigmented inkjet ink may be applied using inkjet printing. In these examples, the dye discharge fluid, the white pigmented inkjet ink, and/or the colored pigmented inkjet ink may be printed at desirable areas. As such, the layer(s) that are formed by the application of the dye discharge fluid, the white pigmented inkjet ink, and/or the colored pigmented inkjet ink may be non-continuous. In other words, the printed-on textile fabric may contain gaps where no fluid is printed.

In some examples, multiple colored pigmented inkjet inks may be inkjet printed onto the at least the portion of the colored textile fabric. In these examples, each of the colored pigmented inkjet inks may include the color pigment, the co-solvent, and the balance of water. However, the color pigment of each of the colored pigmented inkjet inks may be different so that a different color (e.g., cyan, magenta, yellow, black, violet, green, brown, orange, purple, etc.) is generated by each of the colored pigmented inkjet inks. As an example, a combination of two or more colored pigmented inkjet inks selected from the group consisting of a cyan pigmented inkjet ink, a magenta pigmented inkjet ink, a yellow pigmented inkjet ink, and a black pigmented inkjet ink may be inkjet printed onto the at least the portion of the colored textile fabric.

In other examples, a single colored pigmented inkjet ink may be inkjet printed onto the at least the portion of the colored textile fabric.

In some examples of the printing method 100, the white pigmented inkjet ink and/or the colored pigmented inkjet ink is printed while the previously applied layer is wet. Wet on wet printing may be desirable because the printing workflow may be simplified without the additional drying. In an example of wet on wet printing, the white pigmented inkjet ink and/or the colored pigmented inkjet ink is printed onto the previously applied layer within a period of time ranging from about 0.01 second to about 30 seconds after the previously applied layer is printed. In further examples, a respective composition is printed onto the previously applied layer within a period of time ranging from about 0.1 second to about 20 seconds; or from about 0.2 second to about 10 seconds; or from about 0.2 second to about 5 seconds after the previously applied layer is printed.

In other examples of the printing method 100, drying takes place after the application of one composition and before the application of the next composition. It is to be understood that in these examples, drying of the respective compositions may be accomplished in any suitable manner, e.g., air dried (e.g., at a temperature ranging from about 20° C. to about 80° C. for 30 seconds to 5 minutes), exposure to electromagnetic radiation (e.g. infra-red (IR) radiation for 5 seconds), and/or the like.

The dye discharge fluid, the white pigmented inkjet ink, and/or the colored pigmented inkjet ink may be inkjet printed using any suitable inkjet applicator, such as a thermal inkjet printhead, a piezoelectric printhead, a continuous inkjet printhead, etc.

In some examples of the printing method 100, the inkjet printing of the dye discharge fluid, the white pigmented inkjet ink, and/or the colored pigmented inkjet ink may be accomplished at high printing speeds. In an example, the inkjet printing of the dye discharge fluid, the white pigmented inkjet ink, and/or the colored pigmented inkjet ink may be accomplished at a printing speed of at least 25 feet per minute (fpm). In another example, the dye discharge fluid, the white pigmented inkjet ink, and/or the colored pigmented inkjet ink may be inkjet printed at a printing speed ranging from 100 fpm to 1000 fpm.

As shown in reference numeral 104 in FIG. 1, the printing method 100 includes heating the at least the portion of the colored textile fabric. Heating the at least the portion of the colored textile fabric activates the heat activated reducing agent. The activated reducing agent reduces the reactive dye in the at least the portion of the colored textile fabric to its colorless form, which discolors the at least the portion of the colored textile fabric.

In some examples, heating involves exposing the at least the portion of the colored textile fabric to a radiation wavelength ranging from about 350 nm to about 410 nm. In these examples, the dye discharge fluid absorbs at least some of the radiation converts the absorbed radiation to thermal energy, which activates heat activated reducing agent.

In the examples of the printing method 100, the exposure of the at least the portion of the colored textile fabric to electromagnetic radiation having a wavelength ranging from about 350 nm to about 410 nm may be accomplished with a radiation source. In an example, the radiation source may be a light emitting diode having an emission wavelength ranging from 350 nm to about 410 nm. In another example, the radiation source may be a narrow wavelength ultraviolet light source. In still another example of the method 100, the exposing of the at least the portion of the colored textile fabric is accomplished with a narrow wavelength ultraviolet light source having an emission wavelength of 355 nm, 360 nm, 365 nm, 375 nm, 385 nm, 395 nm or 405 nm. In yet another example, the radiation source may be a 395 nm light emitting diode.

In the examples of the printing method 100, the exposure of the at least the portion of the colored textile fabric to electromagnetic radiation having a wavelength ranging from about 350 nm to about 410 nm may take place for an amount of time sufficient to raise a temperature of the at least the portion so that the heat activated reducing agent is activated. In an example, the exposing of the at least the portion of the colored textile fabric to the radiation wavelength may be for a time period ranging from about 0.1 seconds to about 20 seconds. In another example, heating involves exposing the at least the portion of the colored textile fabric to a radiation wavelength ranging from about 350 nm to about 410 nm for a time period ranging from about 0.1 seconds to about 5 seconds. In still another example, the exposing of the at least the portion to the radiation wavelength may be for about 1 second.

The radiation exposure takes place very rapidly with the radiation source. To avoid overheating, it may be desirable to adjust the settings of the radiation source. For example, examples of the printing method 100 may include setting the radiation source to a power setting ranging from about 3.5 W/cm² to about 10 W/cm². The power setting may depend, in part, upon the light source used, the total time for exposure, the distance between the light source and the colored textile fabric, etc. Higher power settings may be desirable for faster throughput systems. In another example, the energy (radiant) exposure ranges from about 0.5 J/cm² to about 20 J/cm². In a specific example, if a power of 10 W/cm² is applied for 1 second, the applied energy is 10 J/cm². In some examples, the electromagnetic radiation results in an energy exposure ranging from about 0.5 J/cm² to about 20 J/cm². In other examples, the electromagnetic radiation results in an energy exposure of about 6.62 J/cm².

The temperature at which activation takes place depends on the heat activated reducing agent used. In some examples, the radiation exposure may raise the temperature of the at least the portion of the colored textile fabric to between about 150° C. and about 190° C., or between about 180° C. and about 200° C. It is to be understood that if the activation temperature of a dye discharge fluid were 150° C., the temperature to which the fabric (having the print thereon) is raised may be any suitable temperature at or slightly above (e.g., +5° C.) 150° C.

It is to be understood that the exposing of the at least the portion of the colored textile fabric to the radiation wavelength may be accomplished using a single continuous pulse exposure of radiation, or a multiple pulsing mode of radiation exposure. As such, in some examples, the exposing of the at least the portion of the colored textile fabric to electromagnetic radiation includes a single exposing event; and, in other examples, the exposing of the at least the portion of the colored textile fabric to electromagnetic radiation includes multiple exposing events. Multiple exposing events including multiple radiation pulses, where the exposure time during each of the individual pulses of radiation may be added to calculate a total exposure time. Examples of this total exposure time fall within the example time period ranges disclosed above.

In some examples, heating involves exposing the at least the portion of the colored textile fabric to heat at a temperature ranging from about 80° C. to about 200° C., for a period of time ranging from about 10 seconds to about 15 minutes. In an example, the temperature ranges from about 100° C. to about 180° C. In still another example, heating involves exposing the at least the portion of the colored textile fabric to heat at a temperature of about 150° C. for about 1 minute. In these examples, the heat activates heat activated reducing agent. In some of these examples, the exposing of the at least the portion of the colored textile fabric to heat is accomplished using a hot press or heat press.

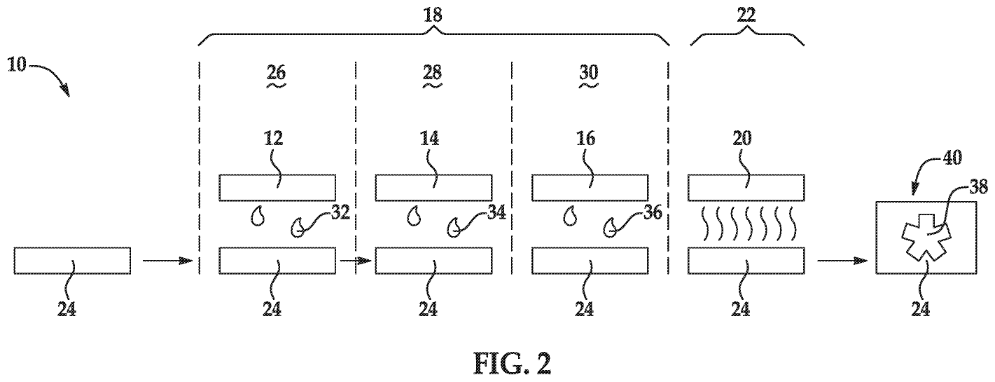

Referring now to FIG. 2, a schematic diagram of a printing system 10 including inkjet printheads 12, 14, 16 in a printing zone 18 of the printing system 10 and a heater 20 positioned in a curing of the printing system 10. It is to be understood that any example of the colored textile fabric 24, any example of the dye discharge fluid 32, any example of the colored pigmented inkjet ink 36, and/or any example of the white pigmented inkjet ink 34 may be used in the examples of the printing system 10.

In one example, a colored textile fabric 24 may be transported through the printing system 10 along the path shown by the arrows such that the colored textile fabric 24 is first fed to the printing zone 18. In the printing zone 18, the colored textile fabric 24 is first transported through a dye discharge zone 26 where an example of the dye discharge fluid 32 is inkjet printed directly onto the colored textile fabric 24 by the inkjet printhead 12 (for example, from a piezo- or thermal-inkjet printhead) to form a dye discharge layer on the colored textile fabric 24. The dye discharge layer disposed on the colored textile fabric 24 may be heated in the printing zone 18 (for example, the air temperature in the printing zone 14 may range from about 10° C. to about 90° C.) such that water may be at least partially evaporated from the dye discharge layer. The colored textile fabric 24 may then be transported through a white ink zone 28 where an example of the white pigmented inkjet ink 34 may be inkjet printed directly onto the dye discharge layer on the colored textile fabric 24 by the inkjet printhead 14 (for example, from a piezo- or thermal-inkjet printhead) to form a white ink layer. The white ink layer may be heated in the printing zone 18 (for example, the air temperature in the printing zone 14 may range from about 10° C. to about 90° C.) such that water may be at least partially evaporated from the white ink layer. The colored textile fabric 24 may then be transported through a colored ink zone 30 where an example of the colored pigmented inkjet ink 36 may be inkjet printed directly onto the white ink layer or directly onto the dye discharge layer on the colored textile fabric 24 by the inkjet printhead 16 (for example, from a piezo- or thermal-inkjet printhead) to form a colored ink layer.

Rather than specific zones 26, 28, 30 where each of the compositions 32, 34, 36 is applied, it is to be understood that the printing system 10 may include one printing zone 18 where inkjet cartridges are moved across the colored textile fabric 24 to deposit the compositions 32, 34, 36. It is also to be understood that the white pigmented inkjet ink 34 and/or the colored pigmented inkjet ink 36 may or may not be applied on the dye discharge layer on the colored textile fabric 24. When the white pigmented inkjet ink 34 and/or the colored pigmented inkjet ink 36 is/are not to be applied, the colored textile fabric 24 is not transported through the respective zone(s) 28, 30.

The colored textile fabric 24 (having the dye discharge fluid 32 and in some instances the white pigmented inkjet ink 34 and/or the colored pigmented inkjet ink 36 printed thereon) may then be transported to the curing zone 22 where the compositions/layers are heated to activate the heat activated reducing agent (in the dye discharge fluid 32) and discolor the portion of the colored textile fabric 24 in contact with the activated reducing agent. When the white pigmented inkjet ink 34 and/or the colored pigmented inkjet ink 36 have also been printed on the colored textile fabric 24, the heat to which the colored textile fabric 24 is exposed may also be sufficient to bind the white pigment and/or the color pigment onto the colored textile fabric 24. The heat to which the colored textile fabric 24 is exposed may range from about 80° C. to about 200° C. The heating of the fluids/print forms the printed article 40 including the image 38 formed on the colored textile fabric 24.

In some examples, the dye discharge fluid 32 may be printed and heated prior to the application of other inks 34 and/or 36.

To further illustrate the present disclosure, examples are given herein. It is to be understood that these examples are provided for illustrative purposes and are not to be construed as limiting the scope of the present disclosure.

### EXAMPLES

### Example 1

Two examples of the dye discharge fluid disclosed herein (ex. fluid 1 and ex. fluid 2) were prepared. The heat activated reducing agent included in each of the example dye discharge fluids was zinc formaldehyde sulfoxylate.

The general formulation of each of the example dye discharge fluids is shown in Table 1, with the wt % active of each component that was used.

TABLE 1

| Ingredient | Specific Component | Ex. fluid 1 | Ex. fluid 2 |
|---|---|---|---|
| Heat activated | Zinc formaldehyde | 6 | 6 |
| reducing agent | sulfoxylate | | |
| Water-soluble | Tetraethylene glycol | 12 | — |
| organic solvent | 2-pyrrolidone | — | 12 |
| Anti-decel | LIPONIC ® EG-1 | 1 | 1 |
| agent | | | |
| Surfactant | BYK ® 348 | 0.15 | 0.15 |
| Water | Deionized water | Balance | Balance |

The stability of ex. fluids 1 and 2 was tested using viscosity. The viscosity of ex. fluids 1 and 2 was measured before accelerated storage, and after each of the fluids was stored in an accelerated storage (AS) environment for one week and for two weeks. The accelerated storage environment was held at 60° C. The viscosity of each of the fluids was measured at room temperature (25° C.) using a Viscolite viscometer before storage, and after storage in the AS environment for the desired time period. Then, the percent change (%Δ) in the viscosity was calculated for each fluid. The viscosity of ex. fluids 1 and 2 before storage, after one week in the AS environment, and after two weeks in the AS environment is shown in Table 2. Table 2 also depicts the calculated %Δ after 2 week storage.

TABLE 2

| | Viscosity | Viscosity | Viscosity | %ΔViscosity |
|---|---|---|---|---|
| | before | after 1 wk | after 2 wk | after 2 wk |
| Fluid | AS (cP) | AS (cP) | AS (cP) | AS |
| Ex. fluid 1 | 1.9 | 1.8 | 1.8 | −5.27 |
| Ex. fluid 2 | 1.6 | 1.5 | 1.6 | 0 |

As shown in Table 2, each of the example fluids had a percentage of viscosity increase of less than 10%. In other words, the viscosity decreased (i.e., the percent change in the viscosity was negative) or the percent change was less than 10%. Thus, each of the example fluids had an acceptable viscosity percent change, which indicates the stability of the fluid compositions.

Several prints were generated using ex. fluid 2. To generate the prints, about 20 gsm of ex. fluid 2 was thermal inkjet printed on a colored textile fabric. No white ink or colored ink was printed on the colored textile fabrics. As such, the “prints” in Example 1 were areas of the colored textile fabric that were exposed to ex. fluid 2. The colored textile fabrics were black 100% cotton, black 50% cotton/50% polyester, and red 50% cotton/50% polyester. Some of the prints were heated with a hot press at 150° C. for 1 minute. Some other of the prints were heated by being exposed to 6.62 J/cm² of UV energy from a 395 nm light emitting diode (LED) operated at 50% power for 1 second. Still some other of the prints were not heated.

The L* value of each print was measured. L* is lightness, and a greater L* value indicates a greater discoloration of the black or red fabric.

The L* value of each print is shown in Table 3. In Table 3, each print is identified by the colored textile fabric and the heating process (if any) used to generate the print.

TABLE 3

| | | | L* Value |
|---|---|---|---|
| | | L* Value | after heating |
| Colored textile | | before | process |
| fabric | Heating process | printing | (if any) |
| Black 100% cotton | None | 15.1 | N/A |
| Black 100% cotton | Hot press at 150° C. for | 15.1 | 44.2 |
| | 1 minute | | |
| Black 100% cotton | 6.62 J/cm² of UV | 15.1 | 30.5 |
| | energy from 395 LED | | |
| Black 50% cotton/ | None | 14.0 | N/A |
| 50% polyester | | | |
| Black 50% cotton/ | Hot press at 150° C. for | 14.0 | 34.4 |
| 50% polyester | 1 minute | | |
| Black 50% cotton/ | 6.62 J/cm² of UV | 14.0 | 24.1 |
| 50% polyester | energy from 395 LED | | |
| Red 50% cotton/ | None | 42.3 | N/A |
| 50% polyester | | | |
| Red 50% cotton/ | Hot press at 150° C. for | 42.3 | 50.0 |
| 50% polyester | 1 minute | | |
| Red 50% cotton/ | 6.62 J/cm² of UV | 42.3 | 47.0 |
| 50% polyester | energy from 395 LED | | |

The increases L* Values for the heated fabrics indicates that the colored fabrics were discolored as a result of heating.

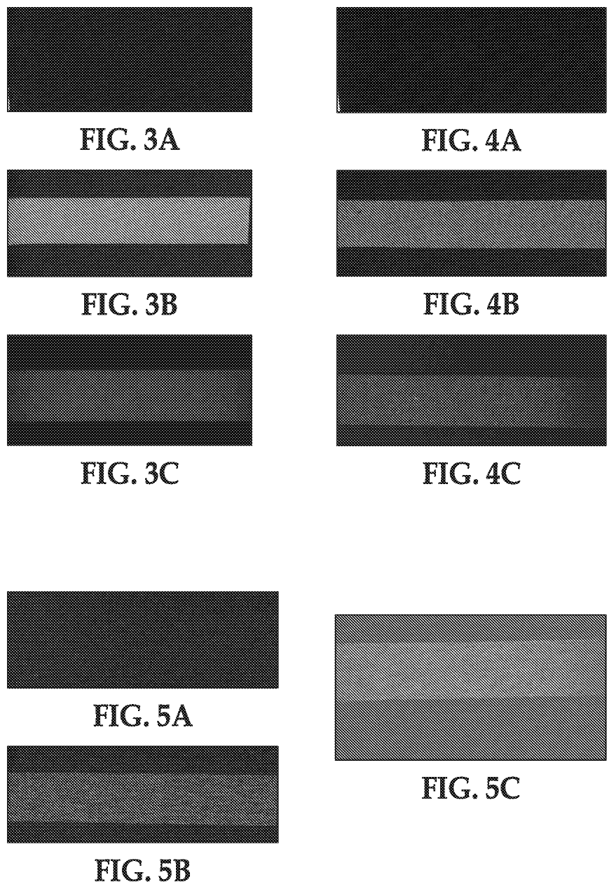

Color photographs of each of prints were taken after the heating process (if any) was performed. The photographs are reproduced in black and white in FIG. 3A through FIG. 5C. The print generated with ex. fluid 2 on black 100% cotton with no heating process is shown in FIG. 3A; the print generated with ex. fluid 2 on black 100% cotton and heated with a hot press at 150° C. for 1 minute is shown in FIG. 3B; and the print generated with ex. fluid 2 on black 100% cotton and heated by being exposed to 6.62 J/cm² of UV energy from a 395 nm LED operated at 50% power for 1 second is shown in FIG. 3C. The print generated with ex. fluid 2 on black 50% cotton/50% polyester with no heating process is shown in FIG. 4A; the print generated with ex. fluid 2 on black 50% cotton/50% polyester and heated with a hot press at 150° C. for 1 minute is shown in FIG. 4B; and the print generated with ex. fluid 2 on black 50% cotton/50% polyester and heated by being exposed to 6.62 J/cm² of UV energy from a 395 nm LED operated at 50% power for 1 second is shown in FIG. 4C. The print generated with ex. fluid 2 on red 50% cotton/50% polyester with no heating process is shown in FIG. 5A; the print generated with ex. fluid 2 on red 50% cotton/50% polyester and heated with a hot press at 150° C. for 1 minute is shown in FIG. 5B; and the print generated with ex. fluid 2 on red 50% cotton/50% polyester and heated by being exposed to 6.62 J/cm² of UV energy from a 395 nm LED operated at 50% power for 1 second is shown in FIG. 5C.

The results in Table 3 and in FIG. 3A through FIG. 5C illustrate that ex. fluid 2 is heat activated. When the prints were not exposed to heat (see FIG. 3A, FIG. 4A, and FIG. 5A), the textile fabrics were not discolored in the printed-on areas. In contrast, when activated by heat (see FIG. 3B, FIG. 4B, FIG. 5B, FIG. 3C, FIG. 4C, and FIG. 5C), the textile fabrics were discolored in the printed-on area. The results in Table 3 and FIG. 3B, FIG. 4B, and FIG. 5B illustrate that heating with a hot press activated ex. fluid 2. The results in Table 3 and FIG. 3C, FIG. 4C, and FIG. 5C illustrate that heating through exposure to UV energy from a 395 nm LED activated ex. fluid 2.

### Example 2

Ex. fluid 2 from Example 1 was used in this example.

Three examples of the colored pigmented inkjet ink disclosed herein (ex. ink cyan, ex. ink magenta, and ex. ink yellow) were also prepared. Each example colored pigmented inkjet ink had the same general formulation except for the pigment dispersion used. The general formulation of each of the example colored pigmented inkjet inks is shown in Table 4, with the wt % active of each component that was used (e.g., wt % active cyan pigment, wt % active magenta pigment, or wt % active yellow pigment). A 5 wt % potassium hydroxide aqueous solution was added to each of the inks until a pH of about 8.5 was achieved.

TABLE 4

| | | Ex. ink cyan | Ex. ink magenta | Ex. ink yellow |
|---|---|---|---|---|
| Ingredient | Specific Component | (wt % active) | (wt % active) | (wt % active) |
| Pigment dispersion | Cyan pigment dispersion | 2.5 | 0 | 0 |
| | Magenta pigment dispersion | 0 | 2.5 | 0 |
| | Yellow pigment dispersion | 0 | 0 | 2.5 |
| Binder | IMPRANIL ® DLN-SD | 6 | 6 | 6 |
| Co-solvent | Glycerol | 8 | 8 | 8 |
| Anti-decel agent | LIPONIC ® EG-1 | 1 | 1 | 1 |
| Anti-kogation agent | CRODAFOS ™ N-3A | 0.5 | 0.5 | 0.5 |
| Surfactant | SURFYNOL ® 440 | 0.3 | 0.3 | 0.3 |
| Antimicrobial agent | ACTICIDE ® B20 | 0.044 | 0.044 | 0.044 |
| Water | Deionized water | Balance | Balance | Balance |

Several prints were generated using ex. fluid 2 (from Example 1) and the example inks. To generate the prints, about 20 gsm of ex. fluid 2 was thermal inkjet printed on colored textile fabrics. Then, about 20 gsm of ex. ink cyan, ex. ink magenta, or ex. ink yellow was thermal inkjet printed on the areas colored textile fabric that were treated with ex. fluid 2. No white ink was printed on the colored textile fabrics. As such, the “prints” in Example 2 were areas of the colored textile fabric that were exposed to ex. fluid 2 and to one of the cyan, magenta, and yellow inks. The colored textile fabrics used were black 100% cotton. Some of the prints were heated with a hot press at 150° C. for 1 minute. Some other of the prints were heated by being exposed to 6.62 J/cm² of UV energy from a 395 nm light emitting diode (LED) operated at 50% power for 1 second. Still some others of the prints were not heated.

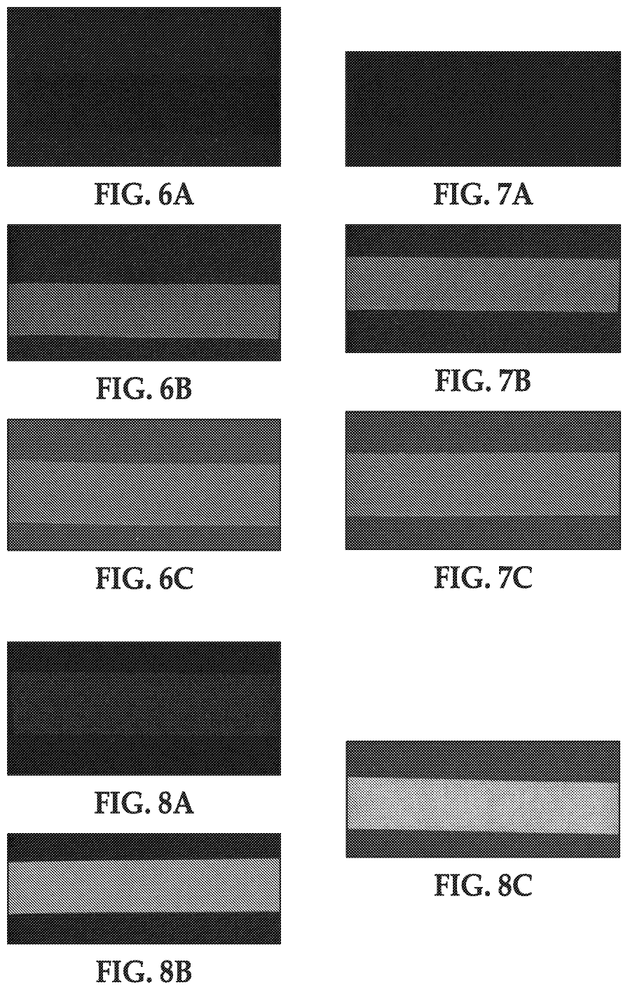

Color photographs of each of prints were taken after the heating process (if any) was performed. The photographs are reproduced in black and white in FIG. 6A through FIG. 8C. The print generated with ex. fluid 2 and ex. ink cyan and no heating process is shown in FIG. 6A; the print generated with ex. fluid 2 and ex. ink cyan and heated with a hot press at 150° C. for 1 minute is shown in FIG. 6B; and the print generated with ex. fluid 2 and ex. ink cyan and heated by being exposed to 6.62 J/cm² of UV energy from a 395 nm LED operated at 50% power for 1 second is shown in FIG. 6C. The print generated with ex. fluid 2 and ex. ink magenta and no heating process is shown in FIG. 7A; the print generated with ex. fluid 2 and ex. ink magenta and heated with a hot press at 150° C. for 1 minute is shown in FIG. 7B; and the print generated with ex. fluid 2 and ex. ink magenta and heated by being exposed to 6.62 J/cm² of UV energy from a 395 nm LED operated at 50% power for 1 second is shown in FIG. 7C. The print generated with ex. fluid 2 and ex. ink yellow and no heating process is shown in FIG. 8A; the print generated with ex. fluid 2 and ex. ink yellow and heated with a hot press at 150° C. for 1 minute is shown in FIG. 8B; and the print generated with ex. fluid 2 and ex. ink yellow and heated by being exposed to 6.62 J/cm² of UV energy from a 395 nm LED operated at 50% power for 1 second is shown in FIG. 8C.

Similar to the results in Example 1, the results in FIG. 6A through FIG. 8C illustrate that ex. fluid 2 is heat activated. When the prints were not exposed to heat (see FIG. 6A, FIG. 7A, and FIG. 8A), the textile fabrics were not discolored in the printed-on areas, and the colored inks are barely (it at all) visible. In contrast, when activated by heat (see FIG. 6B, FIG. 7B, FIG. 8B, FIG. 6C, FIG. 7C, and FIG. 8C), the textile fabrics were discolored in the printed-on area and the colored inks are vibrant. As such, when comparing FIG. 6A with FIGS. 6B and 6C, or FIG. 7A with FIGS. 7B and 7C, or FIG. 8A with FIG. 8B and FIG. 8C, the discoloration of the colored textile fabric by the activated ex. fluid 2 improved the visibility of the colored pigmented inks on the colored textile fabric. The improved visibility was achieved when ex. fluid 2 was activated by heating with a hot press (FIG. 6B, FIG. 7B, and FIG. 8B) and when ex. fluid 2 was activated by exposure to UV energy from a 395 nm LED (FIG. 6C, FIG. 7C, and FIG. 8C).

Further, ex. fluid 2 did not affect the pliability/stiffness (commonly referred to as “hand”) of the prints (as compared to the pliability/stiffness of prints on the same colored textile fabric and including the same amount of colored pigmented inkjet ink and no other fluids).

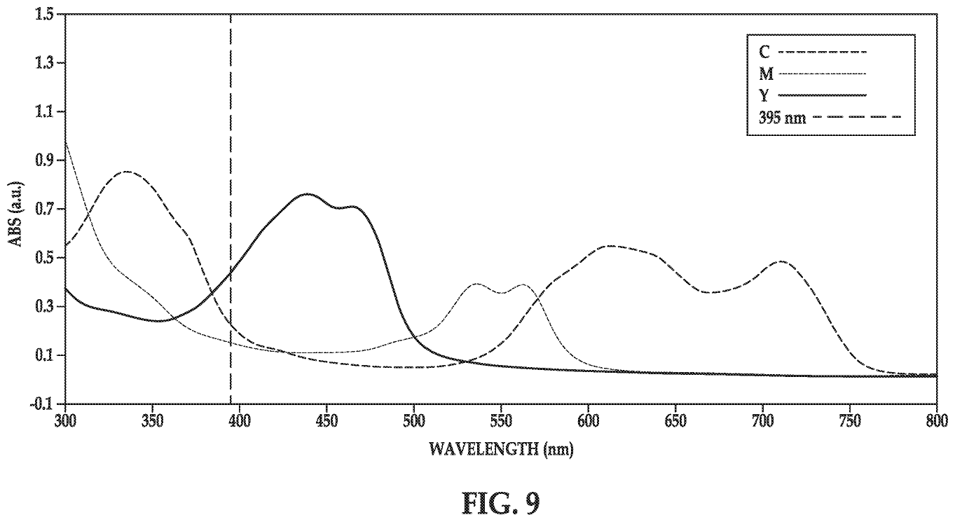

The colored pigmented inks used in this example can absorb UV energy. FIG. 9 shows the UV-VIS spectra of ex. ink cyan, ex. ink magenta and ex. ink yellow (at 1:2500 dilution). The results in Example 2 illustrate that the printed ex. fluid 2 can absorb UV energy from LED better with the application of the colored pigmented inks thereon, since the color pigmented inks also absorb UV energy. As such, it may be desirable to prints the fluids and then utilize the LED heating process.

It is to be understood that the ranges provided herein include the stated range and any value or sub-range within the stated range, as if the value(s) or sub-range(s) within the stated range were explicitly recited. For example, a range from about 3 to about 6, should be interpreted to include not only the explicitly recited limits of from about 3 to about 6, but also to include individual values, such as about 3.15, about 4, about 4.5, about 5, about 5.77, etc., and sub-ranges, such as from about 3.5 to about 4.65, from about 4 to about 5, from about 4.35 to about 5.95, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A dye discharge fluid, comprising:
a water-soluble organic solvent;
a heat activated reducing agent; and
water;
wherein a pH of the dye discharge fluid is less than 7.

2. The dye discharge fluid as defined in claim 1 wherein the heat activated reducing agent is selected from the group consisting of zinc formaldehyde sulfoxylate, sodium formaldehyde sulfoxylate, thiourea dioxide, sodium hydrosulfite, and combinations thereof.

3. The dye discharge fluid as defined in claim 1, further comprising a surfactant.

4. The dye discharge fluid as defined in claim 1 wherein the dye discharge fluid excludes a chelating agent.

5. The dye discharge fluid as defined in claim 1 wherein the heat activated reducing agent is present in the dye discharge fluid in an amount ranging from about 2 wt % to about 16 wt % based on a total weight of the dye discharge fluid.

6. The dye discharge fluid as defined in claim 1 wherein the pH ranges from about 3 to about 6.

7. A printing method, comprising:
inkjet printing a dye discharge fluid on at least a portion of a colored textile fabric, the dye discharge fluid including:
a water-soluble organic solvent;
a heat activated reducing agent; and
water;
wherein a pH of the dye discharge fluid is less than 7; and
heating the at least the portion of the colored textile fabric, thereby activating the heat activated reducing agent and discoloring the at least the portion of the colored textile fabric.

8. The printing method as defined in claim 7 wherein heating involves exposing the at least the portion of the colored textile fabric to a radiation wavelength ranging from about 350 nm to about 410 nm for a time period ranging from about 0.1 sec to about 5 sec.

9. The printing method as defined in claim 8 wherein the electromagnetic radiation results in an energy exposure ranging from about 0.5 J/cm² to about 20 J/cm².

10. The printing method as defined in claim 7 wherein prior to the heating, the method further comprises inkjet printing a colored pigmented inkjet ink on the at least the portion of the colored textile fabric, wherein the colored pigmented inkjet ink includes:
a color pigment;
a co-solvent; and
a balance of water.

11. The printing method as defined in claim 10 wherein the colored pigmented inkjet ink is printed directly on the dye discharge fluid on the colored textile fabric.

12. The printing method as defined in claim 10, further comprising applying a white pigmented inkjet ink on the dye discharge fluid prior to printing the colored pigmented inkjet ink.

13. The printing method as defined in claim 7 wherein heating involves exposing the at least the portion of the colored textile fabric to heat at a temperature ranging from about 80° C. to about 200° C., for a period of time ranging from about 10 seconds to about 15 minutes.

14. A printing kit, comprising:
a colored textile fabric; and
a dye discharge fluid including:
a water-soluble organic solvent;
a heat activated reducing agent; and
water;
wherein a pH of the dye discharge fluid is less than 7.

15. The printing kit as defined in claim 14 wherein the heat activated reducing agent is selected from the group consisting of zinc formaldehyde sulfoxylate, sodium formaldehyde sulfoxylate, thiourea dioxide, sodium hydrosulfite, and combinations thereof.
